(19) United States
(12) Patent Application Publication
(10) Pub. No.: US 2026/0102967 A1
(43) Pub. Date: Apr. 16, 2026

(54) Method for Processing Reactive and Non-Reactive Materials in the Presence of Binder Agents

(71) Applicant: The University of Toledo, Toledo, OH (US)

(72) Inventors: Mohammad Pourshams, Toledo, OH (US); Mohammad Elahinia, Toledo, OH (US); Behrang Poorganji, Toledo, OH (US)

(73) Assignee: The University of Toledo, Toledo, OH (US)

(21) Appl. No.: 19/353,948

(22) Filed: Oct. 9, 2025

Related U.S. Application Data
(60) Provisional application No. 63/705,761, filed on Oct. 10, 2024.

(51) Int. Cl. B29C 64/188; B22F 10/14; B22F 10/20; B29C 64/30; B33Y 10/00; B33Y 40/20

(52) U.S. Cl. CPC B29C 64/188; B22F 10/14; B22F 10/20; B29C 64/30; B33Y 10/00; B33Y 40/20

(57) ABSTRACT

Methods for de-binding in an additive manufacturing process such as binder jetting, as well as methods for de-binding and sintering in an additive manufacturing process such as binder jetting, are described. The methods involve de-binding under fluctuating vacuum pressure, or partially de-binding under air followed by sintering under hydrogen.

### RELATED APPLICATIONS

This application claims priority to U.S. Provisional Application No. 63/705,761 filed under 35 U.S.C. § 111 (b) on Oct. 10, 2024, the entire disclosure of which is incorporated herein by reference for all purposes.

### STATEMENT REGARDING FEDERALLY SPONSORED RESEARCH

This invention was made with government support under Grant No. DE-AC05-00OR22725 awarded by the Department of Energy. The government has certain rights in this invention.

### BACKGROUND

Binder jetting additive manufacturing (BJAM) is widely recognized for its efficiency and capability in mass production, offering substantial advantages in creating complex geometries with a wide range of materials. This technology utilizes a binder to adhere powder particles, forming green parts that are subsequently consolidated through de-binding and sintering. BJAM is a 3D printing process in which a liquid binding agent is selectively deposited onto a powder bed, layer by layer, to bind the powder particles together. The process involves two primary materials: a powder material (often metals, ceramics, or sand) and a liquid binder. Typically, a thin layer of powder is spread across the build platform, a print head moves across the powder bed to deposit the binder in specific areas to create the desired shape in that layer, the binder fuses the powder particles in the regions where the binder is applied forming a solid structure, a new layer of powder is spread over the previous one, and the process repeats until the entire part is built. Once printing is complete, the unbound powder and excess binder are removed, and the printed part may undergo further processing steps.

Binder jetting is recognized as an efficient mass production additive manufacturing method. However, despite its numerous benefits, its application to reactive materials and specific high-performance applications has been limited due to the presence of residual carbon content. Existing binder jetting processes struggle with completely removing the binder, which leads to residual carbon that affects product quality. Residual carbon, originating from the binder, poses significant challenges, particularly for reactive materials such as nickel-titanium (NiTi) alloys and for other components requiring low carbon content. In these cases, carbon residues can adversely affect the mechanical properties and performance of the final products. This issue is especially important in the production of medical devices, where stringent standards mandate low carbon content to ensure biocompatibility and structural integrity. Additionally, producing parts with larger geometries, especially those exceeding 40 mm in thickness, presents significant challenges. Achieving uniform carbon removal in such large components is difficult, often resulting in inconsistent carbon removal throughout the part, which can compromise the quality and reliability of the final product.

Binder jetting is also not the only additive manufacturing process which can involve a need to burn off residual carbon. Processes such as fused deposition modeling (FDM), stereolithography (SLA), digital light processing (DLP), selective layer sintering (SLS), electron beam melting (EBM), direct metal layer sintering (DMLS), directed energy deposition (DED), ultrasonic additive manufacturing (UAM), laminated object manufacturing (LOM), material jetting, hybrid additive manufacturing processes, and ceramic additive manufacturing processes may similarly involve a need to burn off residual carbon.

Current solutions for carbon removal in additive manufacturing include de-binding under hydrogen, argon, and other inert or reducing atmospheres. These methods aim to facilitate the removal of binders while preventing oxidation of the metal powders. However, these approaches often fall short in achieving the desired low carbon content, particularly for highly reactive materials. For example, hydrogen can cause segregation issues, leading to an undesirable separation of nickel from titanium in NiTi alloys. Moreover, the effectiveness of these methods diminishes with increased part size, making it challenging to achieve consistent results in large-scale applications. Additionally, these processes can be complex and costly, and may not be suitable for all types of binder compositions or manufacturing setups. Thus, there is a need in the art for new and improved methods for de-binding or removing residual carbon from a part produced through an additive manufacturing method.

Furthermore, although binder jetting technology is increasingly being adopted across various industries, including the construction, interior design, aerospace, automotive, and healthcare industries, existing binder jetting processes may not work effectively across a wide range of materials and binder compositions, restricting the versatility of additive manufacturing and powder metallurgy. Thus, there is a need in the art for new and improved binder jetting processes.

### SUMMARY

Provided is a method for de-binding a green part in an additive manufacturing process, the method comprising providing a green part from an additive manufacturing process, the green part comprising a binder; and heating the green part in a chamber at an elevated temperature for a period of time while fluctuating vacuum pressure of the chamber to create alternating moments of higher and lower pressure to remove the binder from the green part and produce a part ready for sintering.

In certain embodiments, the additive manufacturing process is a binder jetting process. In certain embodiments, the additive manufacturing process is selected from the group consisting of fused deposition modeling (FDM), stereolithography (SLA), digital light processing (DLP), selective layer sintering (SLS), electron beam melting (EBM), direct metal layer sintering (DMLS), directed energy deposition (DED), ultrasonic additive manufacturing (UAM), laminated object manufacturing (LOM), material jetting, a hybrid additive manufacturing process, and a ceramic additive manufacturing process. In certain embodiments, the chamber comprises air.

In certain embodiments, the elevated temperature is greater than a temperature at which the binder decomposes. In certain embodiments, the elevated temperature is at least 200° C. In certain embodiments, the elevated temperature is about 500° C.

In certain embodiments, the method further comprises sintering the part. In particular embodiments, the sintering is conducted in hydrogen. In particular embodiments, the sintering is conducted in air.

In certain embodiments, the part comprises NiTi. In certain embodiments, the part comprises NiTi, stainless steel, NiTiHf, a nickel-chromium-based alloy, copper, a titanium alloy, aluminum, a tool steel, a cobalt-chrome alloy, silica sand, alumina, silicon carbide, zirconia, hydroxyapatite, polymethyl methacrylate (PMMA), nylon, polypropylene, polycarbonate, a gypsum-based material, a sand-ceramic blend, a metal-ceramic blend, glass, a plaster-based material, quartz sand, chromite sand, olivine sand, graphite, a carbon fiber-reinforced material, a ferrous alloy, a non-ferrous alloy, a superalloy, a shape memory alloy, an amorphous alloy, a high entropy alloy, an intermetallic alloy, a refractory metal alloy, a solder alloy, a bearing alloy, a dental alloy, a polymer blend or alloy, a composite material, a ceramic alloy, an elastomer blend, a bio-composite, a hybrid composite, a nonmetallic conductive alloy, a high-performance nonmetallic alloy, a liquid crystal polymer, or a combination thereof.

In certain embodiments, the binder comprises polyvinyl alcohol, a furan resin, a phenolic resin, polyurethane, sodium silicate, a gypsum-based binder, colloidal silica, an aqueous polymer solution, water with dispersants or surfactants, an epoxy-based binder, an acrylate resin, a methacrylate-based resin, a polymer-latex binder, or a combination thereof.

In certain embodiments, the fluctuating promotes uniform oxidation and carbon removal throughout the green part.

In certain embodiments, the fluctuating vacuum pressure comprises lowering a pressure of the chamber to a first vacuum pressure for a first period of time, then increasing the pressure of the chamber to a second vacuum pressure for a second period of time, wherein each of the first vacuum pressure and the second vacuum pressure is below 760 torr. In particular embodiments, the method further comprises lowering the pressure of the chamber back to the first vacuum pressure for a third period of time. In particular embodiments, the method further comprises lowing the pressure of the chamber to a third vacuum pressure for a third period of time, wherein the first vacuum pressure and the third vacuum pressure are different.

Further provided is a method for de-binding and sintering of a printed part from a binder jetting process, the method comprising providing a printed part from an additive manufacturing process, the printed part comprising a binder; heating the printed part to a first elevated temperature for a first period of time in air to remove some of the binder; sintering the printed part at a first pressure and a second elevated temperature, or an increasing elevated temperature, in hydrogen for a second period of time; heating the printed part at a third elevated temperature in hydrogen for a third period of time; and treating the printed part at a second pressure in hydrogen for a fourth period of time to complete the binder removal and sintering of the printed part; wherein the second elevated temperature is greater than the first elevated temperature, the third elevated temperature is greater than the second elevated temperature, and the second pressure is greater than the first pressure.

In certain embodiments, the printed part comprises NiTi. In certain embodiments, the printed part comprises NiTi, stainless steel, NiTiHf, a nickel-chromium-based alloy, copper, a titanium alloy, aluminum, a tool steel, a cobalt-chrome alloy, silica sand, alumina, silicon carbide, zirconia, hydroxyapatite, polymethyl methacrylate (PMMA), nylon, polypropylene, polycarbonate, a gypsum-based material, a sand-ceramic blend, a metal-ceramic blend, glass, a plaster-based material, quartz sand, chromite sand, olivine sand, graphite, a carbon fiber-reinforced material, a ferrous alloy, a non-ferrous alloy, a superalloy, a shape memory alloy, an amorphous alloy, a high entropy alloy, an intermetallic alloy, a refractory metal alloy, a solder alloy, a bearing alloy, a dental alloy, a polymer blend or alloy, a composite material, a ceramic alloy, an elastomer blend, a bio-composite, a hybrid composite, a nonmetallic conductive alloy, a high-performance nonmetallic alloy, a liquid crystal polymer, or a combination thereof.

In certain embodiments, the first elevated temperature is at least about 275° C. In certain embodiments, the first elevated temperature is in a range of from about 275° C. to about 325° C. In certain embodiments, the first period of time is about 2 hours. In certain embodiments, the method further comprises transferring the printed part to a separate furnace after the heating in air.

In certain embodiments, the additive manufacturing process is selected from the group consisting of fused deposition modeling (FDM), stereolithography (SLA), digital light processing (DLP), selective layer sintering (SLS), electron beam melting (EBM), direct metal layer sintering (DMLS), directed energy deposition (DED), ultrasonic additive manufacturing (UAM), laminated object manufacturing (LOM), material jetting, a hybrid additive manufacturing process, and a ceramic additive manufacturing process.

In certain embodiments, the first pressure is about 300 torr and the second pressure is about 600 torr.

In certain embodiments, the binder comprises polyvinyl alcohol, a furan resin, a phenolic resin, polyurethane, sodium silicate, a gypsum-based binder, colloidal silica, an aqueous polymer solution, water with dispersants or surfactants, an epoxy-based binder, an acrylate resin, a methacrylate-based resin, a polymer-latex binder, or a combination thereof.

Further provided is a method for producing a three-dimensional object, the method comprising depositing a layer of a powdered material onto a build platform; selectively dispensing a liquid binder onto specific regions of the layer of powdered material, based on a digital model of an object to be printed, thereby causing the powdered material in the specific regions to bind together; repeating the depositing and the selectively dispensing steps for multiple layers, wherein each subsequent layer is deposited onto previously bound regions of the powdered material, to form a printed structure through layer-by-layer accumulation; curing the printed structure; removing unbound powdered material from the printed structure; de-binding the printed structure to remove excess binder, wherein the de-binding comprises fluctuating vacuum pressure of a chamber housing the printed structure; and sintering the printed structure to produce a three-dimensional object.

In certain embodiments, the powdered material consists of NiTi. In certain embodiments, the powdered material comprises NiTi, stainless steel, NiTiHf, a nickel-chromium-based alloy, copper, a titanium alloy, aluminum, a tool steel, a cobalt-chrome alloy, silica sand, alumina, silicon carbide, zirconia, hydroxyapatite, polymethyl methacrylate (PMMA), nylon, polypropylene, polycarbonate, a gypsum-based material, a sand-ceramic blend, a metal-ceramic blend, glass, a plaster-based material, quartz sand, chromite sand, olivine sand, graphite, a carbon fiber-reinforced material, a ferrous alloy, a non-ferrous alloy, a superalloy, a shape memory alloy, an amorphous alloy, a high entropy alloy, an intermetallic alloy, a refractory metal alloy, a solder alloy, a bearing alloy, a dental alloy, a polymer blend or alloy, a composite material, a ceramic alloy, an elastomer blend, a bio-composite, a hybrid composite, a nonmetallic conductive alloy, a high-performance nonmetallic alloy, a liquid crystal polymer, or a combination thereof.

In certain embodiments, the liquid binder comprises polyvinyl alcohol, a furan resin, a phenolic resin, polyurethane, sodium silicate, a gypsum-based binder, colloidal silica, an aqueous polymer solution, water with dispersants or surfactants, an epoxy-based binder, an acrylate resin, a methacrylate-based resin, a polymer-latex binder, or a combination thereof.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1: Particle size distribution of NiTi powder in the examples herein. This histogram shows the distribution of particle sizes for NiTi powder used in binder jetting, indicating that the majority of particles fall between 10 and 30 microns. Key percentile sizes are also highlighted: D10 at 13.56 μm, D50 at 23.19 μm, and D90 at 30.68 μm, providing important information for evaluating the powder's suitability for accurate manufacturing applications.

FIG. 2: Differential scanning calorimetry (DSC) thermogram of NiTi alloy. This graph shows the heat flow changes during the heating and cooling phases of the NiTi alloy, illustrating the exothermic and endothermic responses associated with the alloy's phase transitions at varying temperatures.

FIG. 3: Thermogravimetric analysis (TGA) of binder in nitrogen. The TGA curve shows two main weight loss events: the first at around 206.77° C. due to ammonium hydroxide volatilization, and the second at 397.57° C. from polyethyleneimine degradation. A residual mass of approximately 2.475% remains beyond 500° C., indicating most binder components have decomposed.

FIG. 4: Binder jetting process overview. 1. Printing: Powder is spread from a hopper and selectively bound with a binder by a print head, layer by layer. 2. Curing: The printed part is cured to solidify the binder. 3. De-binding: Heat and controlled atmosphere remove the binder. 4. Sintering: The part is sintered at high temperatures to achieve final properties.

FIG. 5: Fishbone diagram of binder jetting variables. The examples herein highlight the important variables affecting the binder jetting process, including pre-process factors such as powder composition and flowability, machine parameters such as carriage speed and humidity, and process variables such as binder composition and layer thickness. De-binding parameters—temperature, pressure, time, and atmosphere—are emphasized as key to achieving ideal carbon removal and material properties.

FIG. 6: Thermogravimetric analysis (TGA) of SPJ-04 binder under air and nitrogen: The TGA curves compare the weight loss of SPJ-04 binder in air (black line) and nitrogen (red line) atmospheres. Both atmospheres exhibit similar decomposition patterns initially, but the final residual mass differs significantly. The air atmosphere results in a lower residual mass (0.22945%) compared to nitrogen (2.50464%), demonstrating the effectiveness of air in fully removing the binder through oxidation.

FIG. 7: Surface and cross-section views of a de-binded part. The top view shows the outer surface appearance of the part, while the bottom view reveals the cross-section, highlighting uneven oxidation and carbon removal. The color gradient from the edges to the center indicates varying levels of oxidation, with more intense oxidation at the edges and less in the core.

FIG. 8: Schematic of air flow and vacuum fluctuation during de-binding. The diagram illustrates the concept of using fluctuating vacuum pressure to achieve uniform air flow throughout the material. The red arrows represent the penetration of air at higher pressure points, predominantly affecting the outer regions, while the green arrows indicate deeper air penetration during lower pressure phases, promoting uniform oxidation and carbon removal throughout the part.

FIG. 9: Uniform color distribution in a de-binded part. The top, bottom, and section views illustrate the results of the de-binding process using air with vacuum pressure fluctuation. The consistent blue color across all views indicates uniform carbon removal and minimal oxidation throughout the entire part, demonstrating the effectiveness of the de-binding method.

FIG. 10: Impurity content in NiTi parts under different de-binding conditions. The graph compares the levels of oxygen (O) and carbon (C) impurities in NiTi parts de-binded under vacuum and argon atmospheres at various temperatures.

FIG. 11: EDS analysis of a NiTi sample de-binded and sintered under pure hydrogen, highlighting elemental distribution of nickel (Ni) and titanium (Ti). Three distinct regions are labeled: Region 1 (near the surface) shows significant nickel segregation with non-uniform distribution; Region 2 exhibits intermediate segregation with higher porosity; and Region 3 (closer to the core) demonstrates a more uniform Ni and Ti distribution. This variation illustrates the effect of hydrogen on elemental diffusion, with greater segregation observed at the surface and decreasing towards the core.

FIG. 12: Carbon and oxygen content in NiTi Parts under various de-binding conditions. The graphs depict the carbon and oxygen impurity levels after different de-binding processes, including air, hydrogen, and partial vacuum conditions. Carbon content shows a significant reduction, with the lowest level of 0.029 wt. % achieved using a combination of air at 280° C. and fluctuating vacuum pressures.

FIG. 13: Impurity content in NiTi parts de-binded under air with vacuum pressure fluctuation. The graph shows carbon and oxygen levels after de-binding using air and vacuum pressure fluctuation at various temperatures and times. The maximum carbon removal was achieved at 450° C. with 60 and 120 minutes, reducing carbon content to 0.030 wt. %. The minimum oxidation, indicated by the lowest oxygen content of 0.324 wt. %, was observed at 450° C. for 30 minutes, demonstrating ideal conditions for carbon removal with minimal oxidation.

FIG. 14: Illustration of results from six different conventional de-binding routes performed under static atmospheres.

FIG. 15: Photograph of surface color gradients observed in de-binded samples processed by classical methods and the methods described herein. The samples containing a circle around them are the samples in which the methods described herein were used.

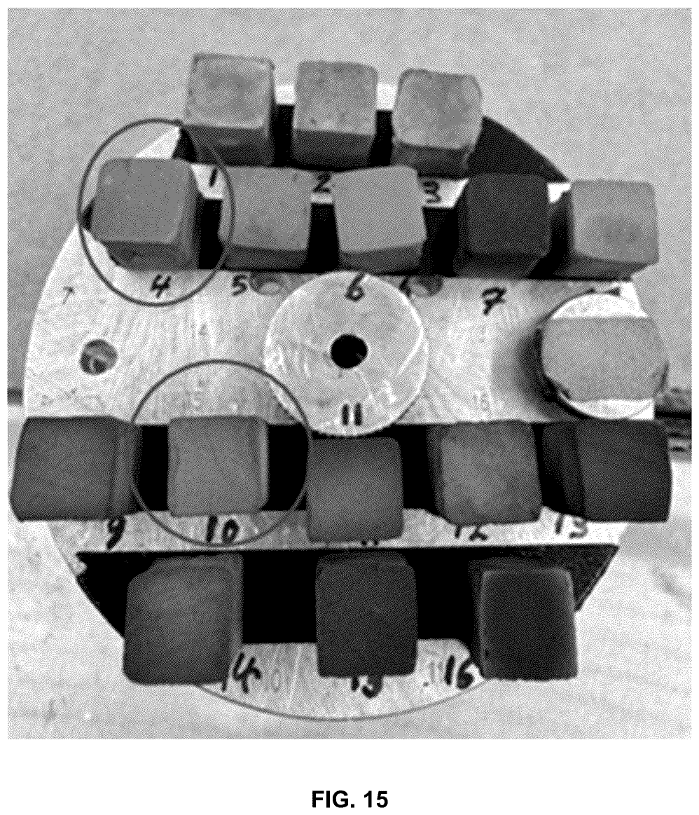

FIG. 16: Illustration of a comparison of oxygen content in mixed and pre-alloyed (NiTiCu) powders under different de-binding conditions: classical methods with static atmospheres and the de-binding method described herein.

FIG. 17: SEM/EDS results and photographs of a sample processed under classical static air atmosphere.

FIG. 18: Photograph of a sample processed under classical static air atmosphere including data lines on the photograph.

FIG. 19: Photograph of the sample illustrated in FIG. 18 processed under classical static air atmosphere including data lines on the photograph.

FIG. 20: Partial enlarged view of the photograph illustrated in FIG. 19 including a data line on the photograph.

FIG. 21: SEM/EDS results of the sample illustrated in FIG. 18 processed under classical static air atmosphere.

FIG. 22: Photograph of a sample processed under classical static air atmosphere including data lines on the photograph.

FIG. 23: Photograph of the sample illustrated in FIG. 22 processed under classical static air atmosphere including data lines on the photograph.

FIG. 24: Partial enlarged view of the photograph illustrated in FIG. 23 including a data line on the photograph.

FIG. 25: SEM/EDS results of the sample illustrated in FIG. 22 processed under classical static air atmosphere.

FIG. 26: Photograph of a sample processed under classical static air atmosphere including data lines on the photograph.

FIG. 27: Photograph of the sample illustrated in FIG. 26 processed under classical static air atmosphere including data lines on the photograph.

FIG. 28: Partial enlarged view of the photograph illustrated in FIG. 27 including a data line on the photograph.

FIG. 29: SEM/EDS results of the sample illustrated in FIG. 26 processed under classical static air atmosphere.

FIG. 30: Illustration the de-binding process described herein under vacuum-air fluctuating atmosphere.

FIG. 31: SEM/EDS results and photographs of de-binded samples through the method described herein.

FIG. 32: Photograph of a de-binded sample processed through the method described herein including data lines on the photograph.

FIG. 33: Photograph of the de-binded sample illustrated in FIG. 32 processed through the method described herein including data lines on the photograph.

FIG. 34: Partial enlarged view of the photograph illustrated in FIG. 33 including a data line on the photograph.

FIG. 35: SEM/EDS results of the de-binded sample illustrated in FIG. 32 processed through the method described herein.

FIG. 36: Photograph of a de-binded sample processed through method described herein including data lines on the photograph.

FIG. 37: Photograph of the de-binded sample illustrated in FIG. 36 processed through the method described herein including data lines on the photograph.

FIG. 38: Partial enlarged view of the photograph illustrated in FIG. 37 including a data line on the photograph.

FIG. 39: SEM/EDS results of the de-binded sample illustrated in FIG. 36 processed through the method described herein.

FIG. 40: Photograph of a de-binded sample processed through the method described herein including data lines on the photograph.

FIG. 41: Photograph of the de-binded sample illustrated in FIG. 40 processed through the method described herein including data lines on the photograph.

FIG. 42: Partial enlarged view of the photograph illustrated in FIG. 41 including a data line on the photograph.

FIG. 43: SEM/EDS results of the de-binded sample illustrated in FIG. 40 processed through the method described herein.

### DETAILED DESCRIPTION

Throughout this disclosure, various publications, patents, and published patent specifications are referenced by an identifying citation. The disclosures of these publications, patents, and published patent specifications are hereby incorporated by reference into the present disclosure in their entirety to more fully describe the state of the art to which this invention pertains.

Provided is a method for making high-precision parts with improved material properties, useful in industries such as the aerospace, automotive, and healthcare industries. The method is efficient and environmentally sustainable, and is useful as part of any additive manufacturing process which involves burning residual binder. One example of such an additive manufacturing process is binder jetting. Unlike some other 3D printing processes such as SLS (Selective Laser Sintering) or FDM (Fused Deposition Modeling), binder jetting does not rely on melting or heat during the printing stage. The binding occurs due to the liquid binder adhering to the powder particles upon contact. In binder jetting, the layer binding is primarily achieved by the chemical reaction between the liquid binder and the powder, rather than by heat during the printing process. The binder acts as an adhesive, fusing the powder particles together in the regions where it is deposited.

As a solution to the limitations in the art, a method has been developed to significantly reduce carbon content in green parts produced via additive manufacturing processes such as, but not limited to, binder jetting. This method involves the tailoring of temperature, atmosphere, time, and vacuum pressure to effectively eliminate carbon residues while protecting the material from oxidation. By enhancing the applicability of additive manufacturing for alloys and processes where low carbon content is crucial, this method represents a significant advancement. As shown in the examples herein, the method can dramatically reduce carbon content, surpassing the performance of conventional carbon removal techniques and complying with stringent standards for medical applications.

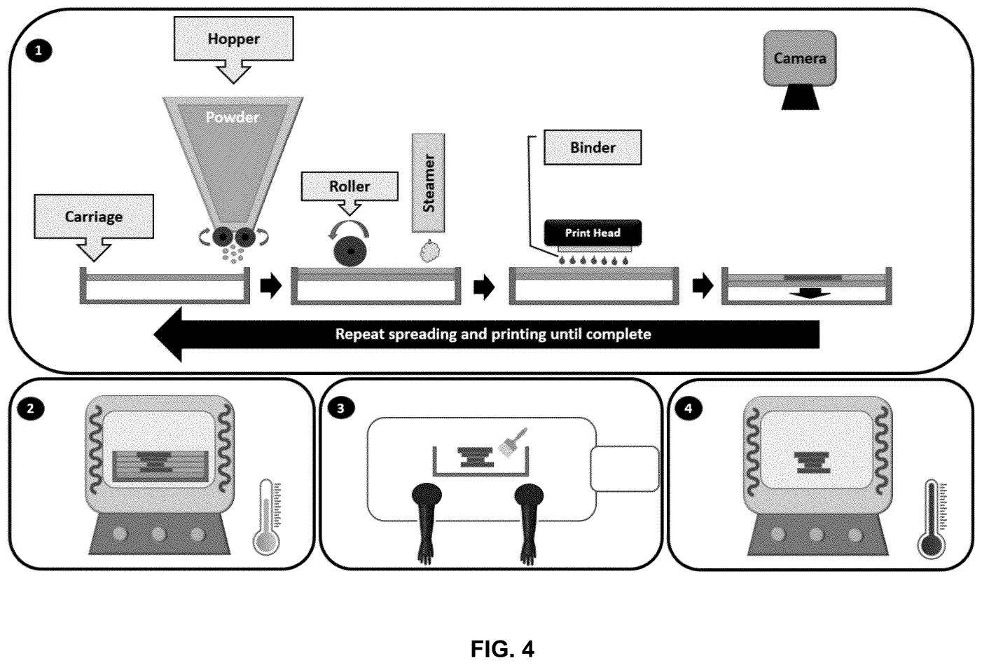

Though the present disclosure describes the additive manufacturing process of binder jetting for the purpose of describing an example, it is understood that the present disclosure may be utilized in any additive manufacturing process which involves burning off residual binder. A non-limiting example binder jetting process is depicted in FIG. 4. A binder jetting process (as a non-limiting example additive manufacturing process) can begin with depositing a layer of a powdered material onto a build platform within a printer chamber. The build platform is a surface onto which the powdered material is deposited and where the part is printed. The build platform is generally a flat, rigid surface to ensure even distribution of the powder layers. The build platform may be mounted on a vertically adjustable system, allowing the build platform to lower incrementally after each powder layer is deposited, facilitating the layer-by-layer building process. The build platform can be made from, for example, metals such as stainless steel or aluminum, or other durable materials that resist wear and exposure to binder and powder particles.

Powder may be deposited onto the build platform. The powder may be of any alloy or mixture of alloys capable of being bound by the binder used in the process. Non-limiting examples of powders used in additive manufacturing processes include stainless steel powders such as 316L stainless steel or 17-4 PH stainless steel; nickel-based alloys such as NiTi, NiTiHf, Inconel 625, Inconel 718 (a nickel-chromium-based alloy); copper powder; titanium alloys such as Ti-6Al-4V; aluminum powder; tool steel powders such as M2 or H13; cobalt-chrome powder; ceramic powders such as silica sand, alumina, silicon carbide, zirconia, or hydroxyapatite; polymer particles such as polymethyl methacrylate (PMMA), nylon, polypropylene, or polycarbonate; composite particles such as gypsum-based powders, sand-ceramic blends, metal-ceramic blends, or glass powders; plaster-based powders; foundry sand powders, such as quartz sand, chromite sand, or olivine sand; carbon-based powders such as graphite powder or carbon fiber-reinforced powders; ferrous alloys (i.e., those containing iron); non-ferrous alloys (i.e., those not containing iron); precious metal alloys (based on noble metals); superalloys (high-performance alloys), shape memory alloys (SMA); amorphous alloys (metallic glasses); high entropy alloys (HEAs); intermetallic alloys; refractory metal alloys (those high melting points); solder alloys; bearing alloys; dental alloys; polymer blends and alloys; composite materials; ceramic alloys; elastomer blends; bio-composites; hybrid composites; nonmetallic conductive alloys; high-performance nonmetallic alloys; liquid crystal polymers (LCP); or a combination thereof. The powder is typically selected based on the desired properties (e.g., strength, thermal resistance, biocompatibility, and surface finish) of the final printed part. The powder can be stored in a powder hopper or feeder next to the build platform and can be either gravity-fed or dispensed through a mechanism such as a roller or a blade. A recoating mechanism (e.g., a roller, blade, or wiper) can spread a thin layer of powder across the build platform, where the thickness of each layer is controlled based on the desired resolution and the material's properties, typically ranging from about 0.05 mm to about 0.2 mm. The recoater can move across the build platform, ensuring the powder is even distributed, and may optionally apply pressure to ensure uniform thickness. The build platform can lower incrementally after each layer to accommodate the next powder layer. For example, the build platform can lower by the height of the previous powder layer to maintain the correct powder layer thickness.

Following powder deposition, a liquid binder is selectively dispensed, such as through a print head, onto specific regions of the layer of powdered material, thereby causing the powdered material in the specific regions to bind together. This can be done based on a digital model of the object to be printed. The binder used can be a polymer, water-based solution, or organic material depending on the powder material. The binder may be an organic binder such as polyvinyl alcohol, a furan resin, a phenolic resin, or a polyurethane binder; an inorganic binder such as sodium silicate, a gypsum-based binder, or colloidal silica; a water-based binder such as an aqueous polymer solution or water with additives such as dispersants or surfactants; an epoxy-based binder; a UV-curable binder such as an acrylate resin or a methacrylate-based resin; a polymer-latex binder; or a combination thereof. Non-limiting examples of commercially available liquid binders include those sold under the names ExOne X1-BN, ExOne X1-BH, ExOne X1-BF, Voxeljet PMMA binder, Voxeljet Furan Binder, Voxeljet Phenolic Binder, ZB56 Binder, ZB60 Binder, HP Fusing Agent, HP Detailing Agent, Desktop Metal Standard Binder, Sandvik Osprey B1 Binder, Sandvik Osprey High-Strength Binder, VisiJet PXL Binder, and VisiJet Clear Binder.

The liquid binder can be dispensed through a print head, which may operate similarly to an inkjet printer by moving across the powder bed and selectively depositing the liquid binder in the areas where the part is being formed. The liquid binder is only applied to the powder regions that correspond to the current layer of the 3D model. At this stage, the non-bonded powder remains loose and acts as support material for the part during the build.

The powder deposition and liquid binder dispensing steps are repeated however many times are necessary to form a part with the desired geometry through layer-by-layer accumulation, at which point the part can be cured with heat to form a fully printed “green part”. The curing is important to strengthen the bond between the binder and the powder material. Depending on the materials used, the bond may not be strong enough to make the part ready for functional use until after curing. Curing solidifies the binder that was applied, strengthening the bonds between the powder particles. The curing step allows the part to gain enough mechanical integrity so that it can be safely handled or moved for further post-processing steps. Curing may involve heating the printed part to initiate the chemical hardening of the binder. The heat causes the binder to dry and solidify, which helps to bond the powder particles together more permanently. The temperature and curing time are carefully controlled to ensure that the binder solidifies without causing distortion to the part. The specific conditions used for the curing depend on the binder material and the powder being used. The part may experience some shrinkage as the binder hardens and excess moisture or solvent evaporates. This can be factored into the design and processing parameters to maintain dimensional accuracy. In some cases, curing may alternatively be done by air drying to harden the part. After curing, the green part is typically strong enough for handling, though it is still relatively fragile and porous compared to fully finished parts.

Unbound powdered material can then be removed from the green part. This de-powdering can be accomplished many different ways, such as by de-powdering the printer chamber with an air nozzle or vacuum system integrated into the printer head, manually brushing around the printed structure, automated brushing around the printed structure, vibration or shaking of the printed structure, compressed air blowing around the printed structure, applying a vacuum to the printed structure, or sieving unbound powder and passing it through a filter for reuse.

Following de-powdering, a thermal de-binding step is conducted to remove the excess binder that holds the powder particles together in the green part. This step is important to prepare the printed object for subsequent processing, such as sintering, and it ensures that only the solid material remains to achieve the desired mechanical properties. During the de-binding, the green part is subjected to controlled heating in a furnace or oven. The goal of de-binding is to eliminate the binder, creating a porous structure of the powder particles which allows the subsequent sintering step to consolidate and densify the part, turning the part into a solid object with enhanced mechanical properties. De-binding is important for part quality and consistency. De-binding prepares the green part for sintering by removing the binder without compromising the shape or structure of the part. Effective de-binding ensures minimal residual carbon content, which is important for maintaining the mechanical properties and performance of reactive alloys such as NiTi.

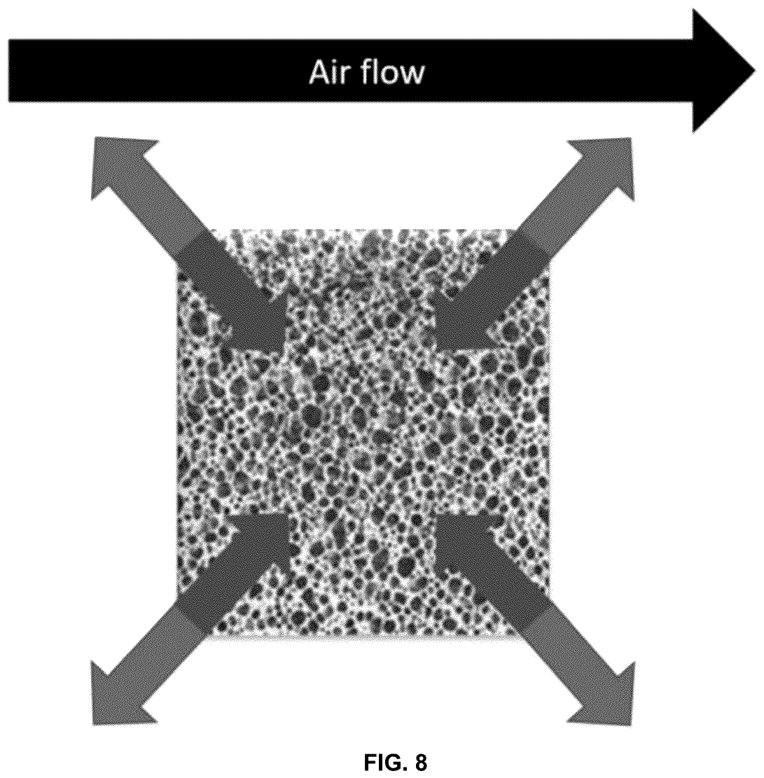

In accordance with the present disclosure, the de-binding step can involve fluctuating the vacuum pressure of the chamber in which the green part is being heated. Vacuum pressure fluctuation creates moments of higher and lower pressure, as depicted in FIG. 8. The higher pressure directs air flow predominantly to the surface while the lower pressure allows deeper air penetration into the center of the part. Advantageously, as described in the examples herein, this allows for consistent carbon removal across the entire material. To accomplish the vacuum fluctuation, the pressure of the chamber may be altered between amounts below 760 torr (i.e., below 1 atmosphere). In one non-limiting example, the vacuum pressure is fluctuated between about 300 torr and about 600 torr. In another non-limiting example, the vacuum pressure is fluctuated between about 200 torr and about 700 torr. In another non-limiting example, the vacuum pressure is fluctuated between about 300 torr and about 500 torr. The process may involve holding the chamber at a first vacuum pressure for a first period of time, then lowering the pressure of the chamber to a second vacuum pressure for a second period of time, then increasing the pressure of the chamber back to the first vacuum pressure for a third period of time, and so on. In other embodiments, the process may involve using more than two different vacuum pressures. For example, the pressure of the chamber may be lowered to a first vacuum pressure for a first period of time, then increased to a second vacuum pressure for a second period of time, then lowered to a third vacuum pressure for a third period of time, where the first vacuum pressure and the third vacuum pressure are different. It should be appreciated that the precise pressures and the duration of time for which each pressure is maintained are matters of customization which depend on various factors such as the materials used and the geometry of the part. The process may be conducted in air as opposed to an inert gas. In other embodiments, however, the process is conducted in an inert gas such as argon. In some embodiments, the process is completely free of hydrogen.

The heating during the de-binding is conducted at a temperature at least as high as the temperature at which the binder in the green part begins to decompose. This may be, for example, at least 200° C. However, other temperatures are possible and encompassed within the scope of the present disclosure. Furthermore, the duration of time that the part is heated for during de-binding widely variable. The duration of heating during de-binding may be, for example, about 1 hour. However, other times are possible and encompassed within the scope of the present disclosure. In any additive manufacturing process, there are numerous parameters which are customized and tailored based on, for instance, the geometry of the desired part to be printed. Thus, parameters such as the temperature that the de-binding chamber is heated to for the de-binding, and the duration of time that the part is heated for during de-binding, may vary dramatically based on factors such as the size and shape of the part. So, while certain heating times and temperatures are disclosed, it is understood that these are merely examples.

The de-binding method described herein can significantly reduce carbon content in green parts. Through the tailoring of temperature, atmosphere, time, and vacuum pressure, the method enhances the applicability of additive manufacturing processes such as binder jetting for alloys and processes where low carbon content is crucial. In the examples herein, NiTi alloys were used, and experiments were conducted using thermogravimetric analysis (TGA), Energy Dispersive Spectroscopy (EDS) analysis, oxygen/nitrogen/hydrogen analysis (ONH-p), and carbon/sulfur analysis (CS-i). The experimental results demonstrated a marked reduction in carbon content, exceeding the performance of conventional carbon removal techniques and complying with stringent standards for medical applications.

Once the unbound powdered material and the binder are removed from the printed structure, the printed structure can be subjected to one or more additional post-processing steps to enhance mechanical properties. Post-processing steps include, but are not limited to, drying, sintering, or infiltration with a secondary material. In some cases, the part goes from de-binding directly to an oven or furnace for sintering. This transfer is conducted carefully because the part is fragile after de-binding, being composed of a loosely bound structure with binder holding the powder particles together. In other cases, the part is carefully cleaned to remove any loose powder or contaminants prior to sintering.

Sintering involves heating the part to just below the melting point of the powder material, which causes the powder particles to fuse together and densify, creating a solid, strong part. Sintering is important in transforming the fragile, porous green part into a solid, strong, and usable component. Sintering increases the density of the part by causing the powder particles to bond at their contact points. This strengthens the part and improves its mechanical properties. Sintering reduces the porosity in the printed mark, making it less porous and more resistant to stress. Sintering ensures the final part has the desired material properties such as hardness, strength, and thermal stability. Sintering may involve placing the part in a furnace and heating the furnace to a temperature between about 70%-90% of the melting point of the powder material. The exact temperature and time depend on the material being sintered. Sintering may take place in a controlled atmosphere, such as in an inert gas (e.g., argon) or a vacuum, to prevent oxidation of metal parts. This is especially important for materials such as stainless steel or titanium. The part experiences shrinkage during sintering as the particles move closer together. This shrinkage can be significant and may therefore be accounted for in the design in the part. After sintering is complete, the furnace may be gradually cooled down, which helps to avoid internal stresses or warping of the part. Once cooled, the part has reached its final, solid state.

In an alternative embodiment, the green part is partially de-binded in the presence of air and sintered in pure hydrogen. This process allows for some binder to be removed prior to exposure to the hydrogen. While this method is not suitable for some materials, it may be useful in some cases to ensure complete binder removal and effective sintering while minimizing segregation issues.

Infiltration is also an optional post-processing step in binder jetting and other additive manufacturing processes, which involves filling porosity with another material (typically a metal with a lower melting point) to affect the strength, density, or surface finish of the part. Porosity can reduce the strength and durability of a part. Infiltration fills these pores, increasing the part's density. Infiltration adds strength and toughness to the part, making it suitable for more demanding applications. Infiltration can also improve the surface finish, reducing roughness and sealing the part's surface. Also, for parts that need to be airtight or watertight, infiltration is important to seal the internal pores and prevent fluid leakage.

Infiltration may begin with an already sintered part that is porous and has not yet reached full density. The part may be cleaned to remove any debris or contaminants, ensuring a good bonding between the part and the infiltrant. Non-limiting example infiltrants include bronze, copper, or a resin. The infiltrant is heated until it melts in a furnace where the part and the infiltrant are placed together. The melting temperature of the infiltrant is carefully controlled to ensure it flows easily into the porous structure of the sintered part without melting the part itself. The molten infiltrant is drawn into the porous structure of the part through capillary action. The infiltrant flows into the pores during the process, effectively filling them. The infiltration process can be assisted by pressure or vacuum techniques to ensure the infiltrant reaches all areas of the part. Once the pores are filled, the part and infiltrant are allowed to cool down. As the infiltrant solidifies, it bonds with the sintered material, forming a denser, stronger structure. The infiltrated material also seals the surface, improving the overall finish and reducing surface porosity. However, an infiltration step is not necessary.

The method herein may expand the use of binder jetting technology and other binder-based manufacturing processes to a broader range of materials and applications, thereby improving efficiency, performance, and applicability in critical applications. Though binder jetting is described herein for exemplary purposes, it is understood that the de-binding method described herein is applicable to other manufacturing processes involving binders, such as, but not limited to, injection molding (MIM), ceramic injection molding (CIM), tape casting, extrusion-based additive manufacturing, powder metallurgy, lithography-based ceramic manufacturing (LCM), and fused deposition modeling (FDM) with metal or ceramic filaments. By improving the efficiency, performance, and applicability of these processes, the method represents a significant advancement in the field of additive manufacturing.

### EXAMPLES

### Example 1

NiTi alloys were used, and extensive experiments were conducted using thermogravimetric analysis (TGA), oxygen/nitrogen/hydrogen analysis (ONH-p), and carbon/sulfur analysis (CS-i), to evaluate the method disclosed herein. The results demonstrated a marked reduction in carbon content, surpassing the performance of conventional carbon removal techniques and complying with stringent standards for medical applications.

### Materials and Experimental Method

### Powder Characterization

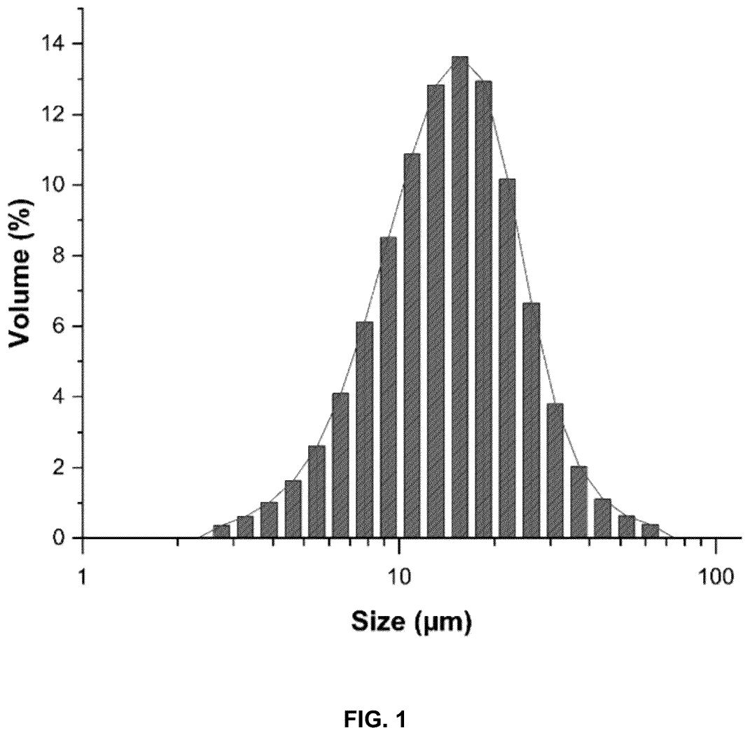

A Ni-rich ingot, consisting of 50.8% Ni and 49.2% Ti by atomic percentage, was processed into powder using electrode induction melting gas atomization (EIGA), performed by TLS Technik GmbH in Bitterfeld, Germany. The resulting NiTi powder featured a spherical shape with low impurity content. The particle size distribution and morphology were determined using the Microtrac SYNC particle analyzer, with D10, D50, and D90 values measured at 13.56 μm, 23.19 μm, and 30.68 μm, respectively, and an average sphericity of 0.922. These particle size distribution details are shown in FIG. 1.

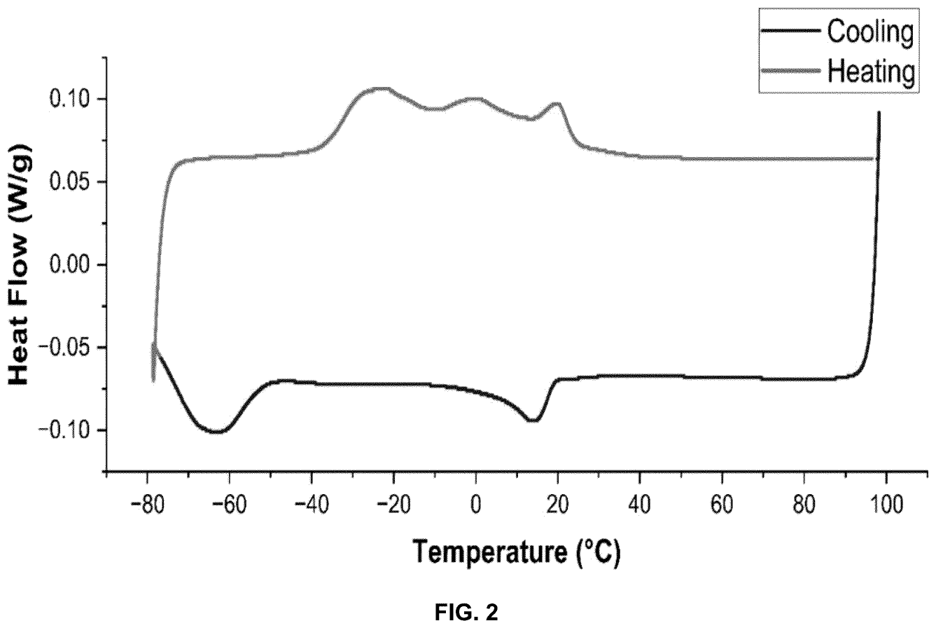

The DSC curve in FIG. 2 shows the transformation temperatures of the NiTi powder. During cooling, the transition from austenite to R-phase begins at 18.56° C. and ends at 7.53° C., while the transformation to martensite starts at −51.86° C. and completes at −79.85° C. During heating, the transition from martensite to R-phase occurs between −36.47° C. and 10.79° C. with austenite forming between 15.07° C. and 24.06° C. The presence of additional peaks indicates variations in grain size.

Table 1 presents the impurity levels in NiTi powder, highlighting its chemical purity, which is important for high-performance applications. Table 1 lists the concentrations of carbon, oxygen, hydrogen, nitrogen, and sulfur in the alloy, showing notably low levels: carbon at 0.031%, oxygen at 0.086%, and hydrogen at 0.00033%, with nitrogen and sulfur effectively negligible. This data provides a benchmark for impurity assessment, offering a clear baseline for ensuring that NiTi powders meet the stringent specifications required for advanced manufacturing processes. The low impurity levels are especially important for applications demanding high material integrity and consistent properties, such as biomedical implants and aerospace components, where even slight contamination can greatly impact the material's performance.

Table 1—Elemental impurities in NiTi powder for additive manufacturing. This table quantifies the concentrations of key elements such as carbon, oxygen, hydrogen, nitrogen, and sulfur in NiTi powder, highlighting the material's purity essential for advanced manufacturing applications.

| | Carbon | Oxygen | Hydrogen | Nitrogen | Sulfur |
|---|---|---|---|---|---|
| | (wt. %) | (wt. %) | (wt. %) | (wt. %) | (wt. %) |
| NiTi powder | 0.031 | 0.086 | 0.00033 | ~0 | ~0 |

### Binder Characterization

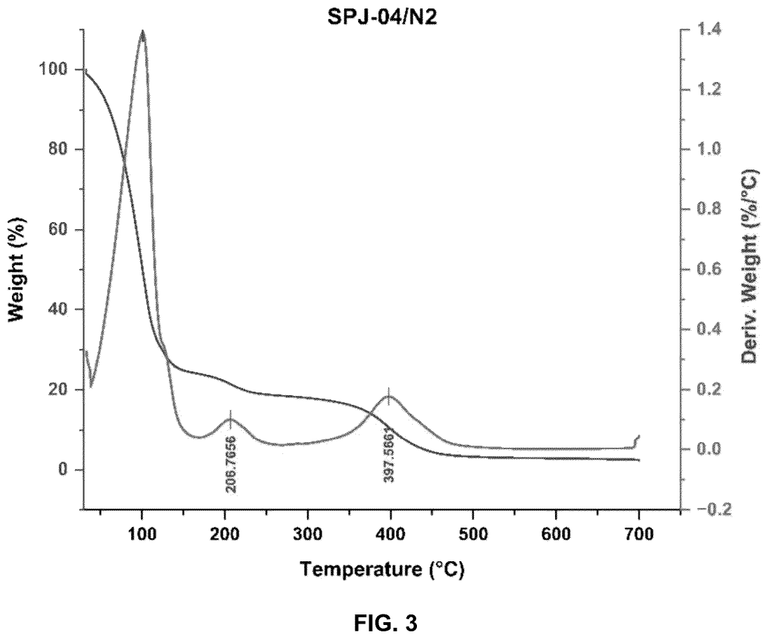

In additive manufacturing, particularly in binder jetting technologies, the choice of binder is important for determining the efficiency of the printing process and the quality of the final products. In this example, Desktop Metal's SPJ-04 binder, a clear, amber liquid, was used. The SPJ-04 binder comprises ammonium hydroxide (NH₄OH) and polyethyleneimine ((CH₂CH₂NH)ₙ). To evaluate its thermal behavior, TGA was conducted. In this method, the binder sample was subjected to a controlled heating program, where its weight loss was continuously measured as the temperature increased. The TGA profile of the binder, shown in FIG. 3, reveals two distinct weight loss peaks after curing at 165° C.: the first peak, at 207° C. is associated with solvent evaporation, while the second peak, around 398° C., indicates the thermal degradation of the binder's polymeric structure. TGA is a valuable tool for understanding the thermal stability and decomposition behavior of binders, ensuring effective binder removal and minimal residual weight of 2.47 wt. % at the end of the analysis.

### Fabrication

The binder jetting AM process for fabricating high-quality NiTi components, shown in FIG. 4, involves several stages. First, NiTi powder is spread across the build platform, and a print head deposits binder according to the desired geometry. Next, the part undergoes curing in a furnace to harden the binder, creating a “green part.” This part is then de-powdered in a glove box, removing excess powder to achieve the near-net shape. The part is heated to remove residual binder in the de-binding stage, forming a “brown part.” and then sintered in the same furnace to densify the NiTi particles and achieve the final material properties and dimensional accuracy.

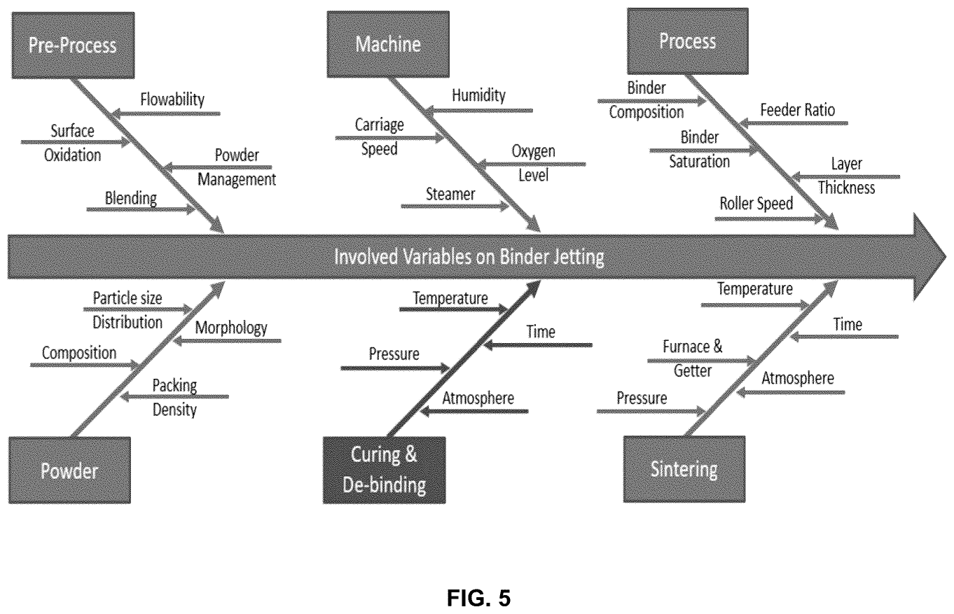

There are many variables involved in the binder jetting process, as illustrated in FIG. 5. Each set of parameters shown in the fishbone diagram can significantly influence the final properties of the manufactured components, including relative density, surface roughness, shrinkage, oxygen pickup, residual carbon, cracking, and microstructure. Residual binder after the de-binding process presents a major challenge, particularly for specific materials and applications, such as in the medical field where residual binder is unacceptable. Over the years, methods such as adding oxygen to facilitate the conversion of carbon to carbon-dioxide, or hydrogen to form methane, have been explored. However, introducing oxygen has led to significant oxidation, which adversely affects the material properties. Furthermore, introducing hydrogen, aside from its cost and safety concerns, has proven ineffective for certain alloys, such as titanium. This highlights the need for advanced and tailored de-binding techniques to effectively address residual binder issues and adjust the final properties of reactive alloys produced through binder jetting additive manufacturing. Key parameters in this process include temperature, time, atmosphere, and pressure. Each of these factors can be carefully controlled to ensure complete binder removal while maintaining the integrity of the alloy, minimizing oxidation and other unwanted reactions.

In general, de-binding can take place under a nonreactive gas such as argon or nitrogen, and could take place under hydrogen although hydrogen could cause reactions between carbon and hydrogen which generate methane. Although the presence of oxygen has been studied to improve the de-binding process, the main concern with de-binding under oxygen, which was oxidation, remains. The reason for this concern is that the binder covers the surface of the powder and the green part has a sponge structure and oxygen will have a reaction with the carbon on the outer area of the sample first. So, after de-binding under the presence of oxygen, there is a distribution of carbon burn from ‘fully burn’ on the outer area to ‘not burn’ in the center area. Also, for oxygen there is a same distribution, which is more oxidation on the outer area to no oxidation at the center. This happens because at the surface there is more chance of contact between oxygen and carbon, and after finishing the carbon from the surface the oxidation will start while carbon still exists at the center.

In these examples, various de-binding methods were explored to tailor the carbon removal process.

### De-Binding Under Argon and Vacuum

De-binding under argon and vacuum was conducted using a tube furnace (STF-1700, Across International) to effectively remove the binder from the green parts while preventing oxidation and minimizing residual carbon content. During the argon de-binding process, an inert argon gas flow was maintained within the furnace to create a non-reactive atmosphere, reducing oxidation risks, and facilitating the thermal decomposition and removal of binder components. In vacuum de-binding, the tube furnace was operated under reduced pressure, which lowered the boiling point of volatile binder constituents, enhancing their removal. Both methods involved precise control of temperature and heating rates to achieve ideal binder removal while maintaining the structural integrity of the green parts, preparing them for subsequent sintering. The de-binding stage was designed based on insights from TGA analyses, which indicated that the binder begins to decompose at approximately 200° C., undergoing significant mass loss as temperature increases. To ensure complete binder removal while mitigating oxidation risks-indicated by weight gain during TGA of the green parts-de-binding was performed at 500° C. for one hour under both argon and vacuum atmospheres. This temperature and duration were sufficient to promote binder volatilization beyond the decomposition threshold while preserving the integrity of the NiTi matrix.

### De-Binding Under Hydrogen

To address the challenges of de-binding and sintering under hydrogen, a two-step process was implemented. Initially, green parts underwent partial de-binding in a controlled air environment at three different temperatures—275° C. 300° C., and 325° C.—for two hours to remove some binder before exposure to hydrogen. This step allowed for a systematic evaluation of how temperature affects the final product quality, with an additional sample skipping this step for comparison. After the air de-binding, the parts were transferred to a separate furnace (MIM3000, Elink System) for de-binding and sintering under pure hydrogen. The process began at a pressure of 300 torr, with a rapid temperature increase to 300° C. followed by a slow ramp of 2° C. per minute to reach 425° C., where it was held for 2 hours. The temperature was then slowly increased to 500° C. for an additional 2-hour hold, after which the pressure was raised to 600 torr. This method aimed to ensure complete binder removal and effective sintering while minimizing segregation issues.

### De-Binding Method Under Air

A de-binding method under air was also developed. In the binder jetting additive manufacturing process, binder is injected onto the surface of the powder bed layer by layer, effectively coating the powder particles. By leveraging this phenomenon, air was introduced to first oxidize the carbon, converting it into carbon dioxide for removal, before causing any oxidation of the NiTi alloy. Using feedback from experimental results and TGA, the ideal temperature and time for maximum carbon removal and minimal oxidation of the NiTi were determined based on the oxidation rates.

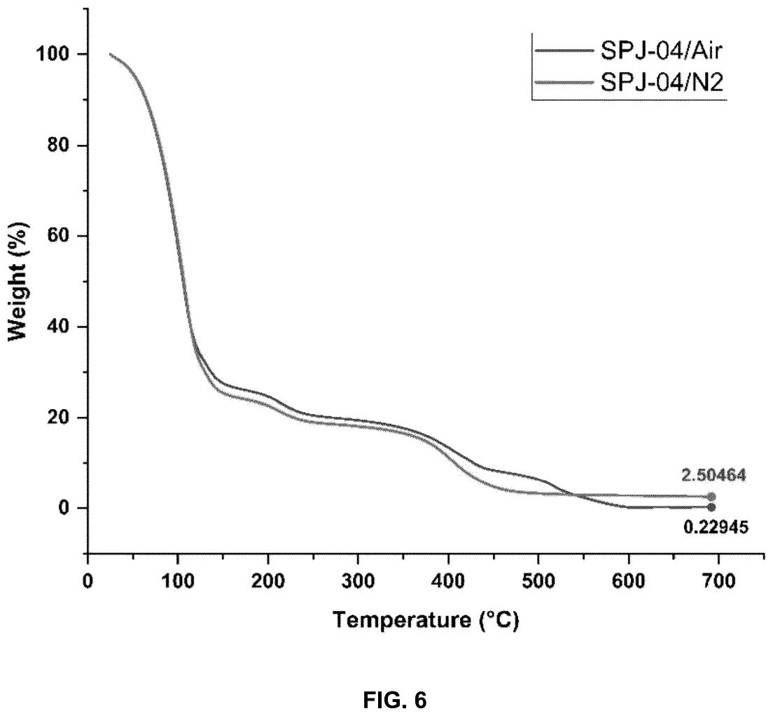

The effectiveness of air in binder removal was confirmed by the TGA results comparing the decomposition of the binder (SPJ-04) under air and nitrogen, as shown in FIG. 6. Under air, the binder left a residual mass of only 0.22945%, whereas under nitrogen, the residual mass was significantly higher at 2.50464%. This result demonstrates the superior ability of air to oxidize and fully remove the binder compared to nitrogen which, as an inert gas, prevents complete binder breakdown. These findings emphasize the importance of using air for enhanced carbon removal during the de-binding process.

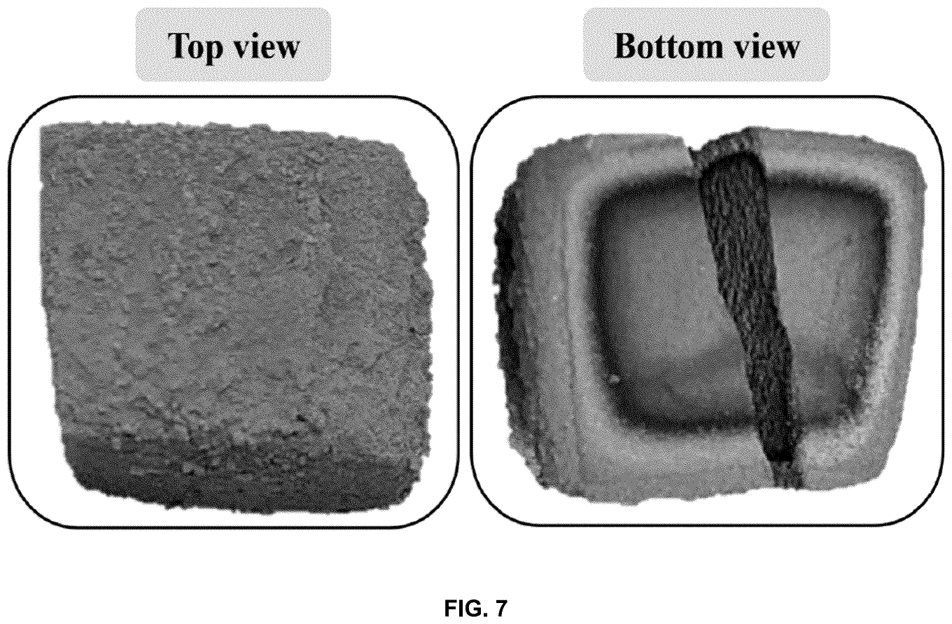

Once the best parameters were identified, it was observed that oxidation was not uniform. Rather, the surface layers exhibited more oxidation and greater carbon removal, while the center showed less oxidation and, compared to de-binding under argon, little to no carbon removal. This uneven oxidation was also evident from the color change of the NiTi, indicating that oxidation was occurring not just in the binder but also in the NiTi alloy itself, as shown in FIG. 7. In the top view, a relatively uniform surface appearance is observed, while the bottom view reveals a distinct color gradient. The outer edges exhibit a range of colors from brown to blue, indicating varying degrees of oxidation and carbon removal. In contrast, the inner core remains largely unchanged, reflecting limited oxidation and carbon removal.

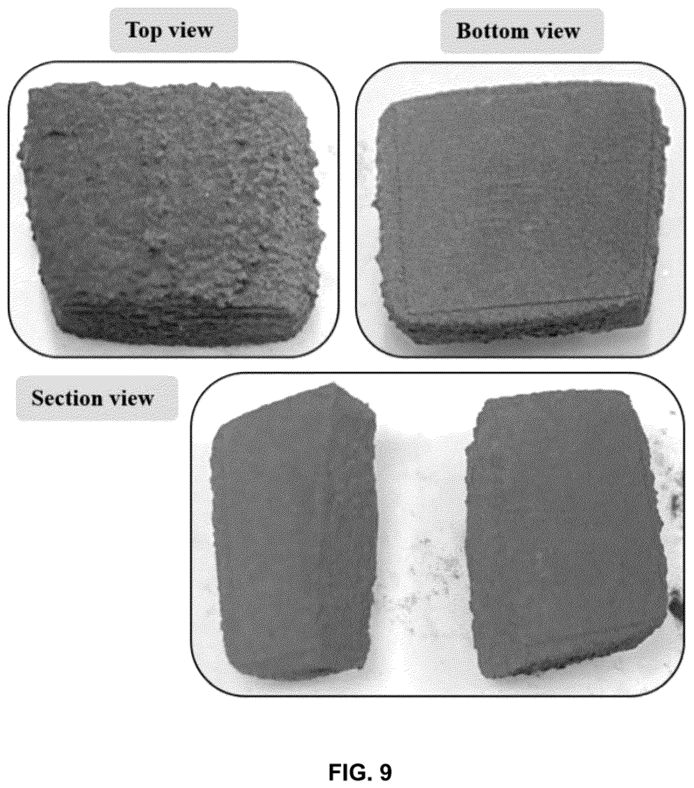

To address this issue and achieve uniform de-binding, fluctuating the vacuum pressure during de-binding to create alternating moments of higher and lower pressure, as depicted in FIG. 8, was devised. The red and green arrows in the schematic represent these fluctuations, where higher pressure directs air flow predominantly to the surface, and lower pressure allows deeper air penetration into the center of the part. FIG. 9 shows a sample de-binded using the same parameters as the sample in FIG. 7, but with the introduction of vacuum pressure fluctuations. This approach resulted in a uniform color distribution throughout the part, indicating consistent carbon removal across the entire material. The next step involves tailoring the time and temperature, along with specific air flow rates, to precisely halt the process once carbon removal is complete, without causing excessive oxidation of the NiTi alloy.

A tube furnace (STF1200 50×600 mm, Across International) was used for the de-binding process, with a vacuum pressure controller (DigiVac, FYRA) and a vacuum pump (Edwards 6.9 cfm RV8) to manage the pressure fluctuations. This controlled fluctuation helps to balance the air flow, ensuring consistent oxidation and carbon removal across the entire part, while minimizing unwanted oxidation of the NiTi alloy. By facilitating a more uniform distribution of air, this method ensures that both surface and inner regions experience adequate oxidation, leading to uniform material properties and maintaining the integrity of the final sintered parts.

### Results and Discussion

The objective of evaluating different de-binding atmospheres was to identify ideal de-binding conditions that maximize carbon removal while minimizing oxidation of the NiTi alloy. Two primary sets of conditions were studied: the influence of vacuum versus argon atmospheres, and the impact of air with partial vacuum pressure versus a 5% hydrogen atmosphere.

Influence of Vacuum Vs. Argon Atmospheres

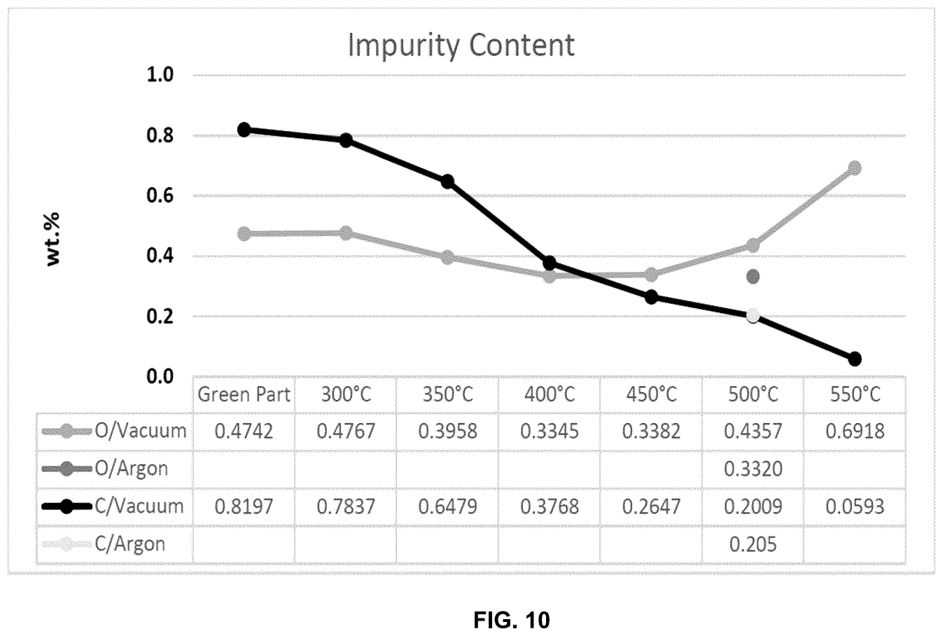

The impurity content of oxygen and carbon in NiTi parts was measured under de-binding temperatures ranging from 300° C. to 550° C., using both vacuum and argon atmospheres. These temperatures were selected based on TGA results, which indicated the binder begins to decompose significantly around 200° C. As shown in FIG. 10, vacuum de-binding was effective in reducing carbon content, consistently lowering it from 0.8197 wt. % in the green part to 0.0593 wt. % at 550° C. In contrast, only one data point was available for de-binding under argon at 500° C., where the carbon content was comparable to that under vacuum, measured at 0.205 wt. %. This indicates that both methods can achieve substantial carbon removal at higher temperatures, though vacuum appears more consistent across a range of temperatures.

Regarding oxygen content, a different trend was observed. While vacuum conditions effectively reduced carbon, they also led to a noticeable increase in oxygen content at higher temperatures, reaching 0.6918 wt. % at 550° C. This indicates that vacuum conditions, while beneficial for carbon removal, may enhance the reactivity of the remaining gases, leading to increased oxidation. In comparison, the oxygen content for the sample de-binded under argon at 500° C. was lower (0.3320 wt. %), indicating that argon may provide a more stable environment for maintaining lower oxygen levels and thus, reduced oxidation. These observations highlight the importance of tailoring de-binding conditions to balance carbon removal with minimal oxidation to preserve the material properties of the NiTi alloy.

### Influence of Pure Hydrogen

The use of hydrogen during the de-binding and sintering process of NiTi alloys has been explored for its ability to reduce residual carbon. However, hydrogen can also contribute to elemental segregation, particularly affecting nickel distribution. This segregation often results in non-uniform microstructures, which can compromise the mechanical and functional properties of NiTi alloys. Hydrogen's interaction with nickel, especially at elevated temperatures, promotes the diffusion of nickel, creating regions with localized Ni-rich areas and disrupting the homogeneity important for ideal shape memory and superelastic behavior.

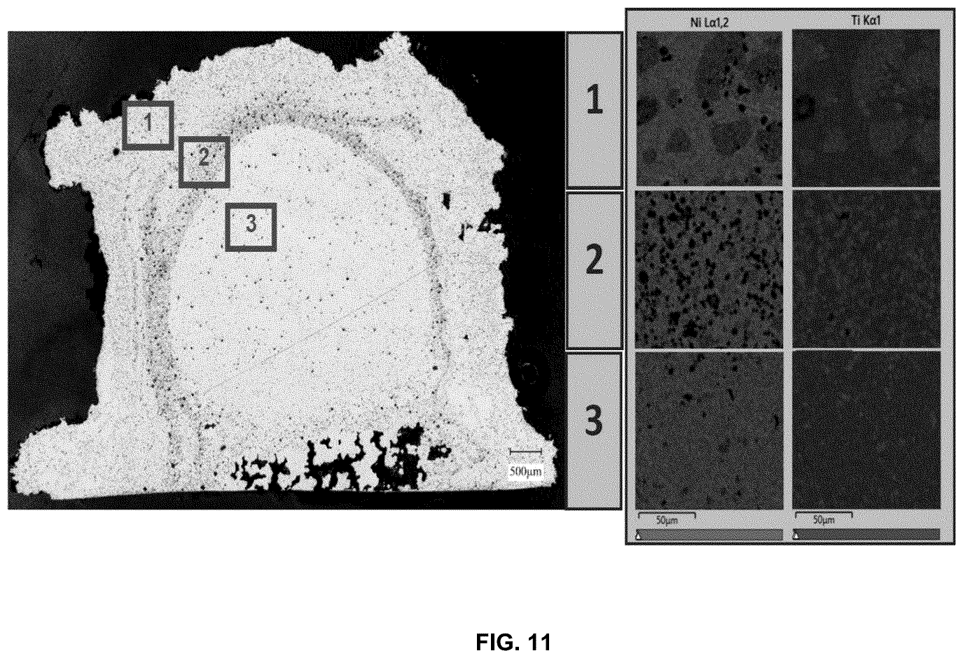

EDS analysis in FIG. 11 illustrates the effects of hydrogen-induced segregation in a NiTi sample. The microstructure is divided into three distinct regions from the surface to the core (labeled 1, 2, and 3), with the corresponding EDS maps showing the elemental distribution of nickel (Ni) and titanium (Ti). Region 1, located near the surface, shows significant Ni segregation, as hydrogen promotes localized concentration of nickel. Region 2, moving further inward, demonstrates reduced but still present segregation, with increased porosity and non-uniform elemental distribution. Finally, Region 3, near the core, shows a more homogeneous distribution of Ni and Ti, indicating that the influence of hydrogen decreases towards the center, allowing for more balanced diffusion.

This analysis highlights how hydrogen can exacerbate elemental segregation, particularly at the surface, and gradually diminish in its effect toward the sample's center, which may lead to non-optimal properties in NiTi alloys sintered under pure hydrogen.

### Influence of Air/Hydrogen/Partial Vacuum Pressure

Building on the concept of using air for de-binding to control oxidation, the investigation began with a two-step de-binding process: initially de-binding under air at low temperatures, followed by using 5% hydrogen balanced with argon at higher temperatures. The purpose was to first oxidize and remove carbon at a controlled rate using air, then reduce any remaining carbon using hydrogen while minimizing oxidation of the NiTi alloy.

Through varying the temperature and time parameters, it became evident that while this two-step process effectively reduced carbon content, controlling oxygen uptake remained a challenge. To address this, partial vacuum conditions at 300 torr were introduced during the air de-binding step. The introduction of partial vacuum aimed to improve air penetration and uniformity of carbon removal, as well as to reduce the oxidation potential by controlling the exposure of the part to air.

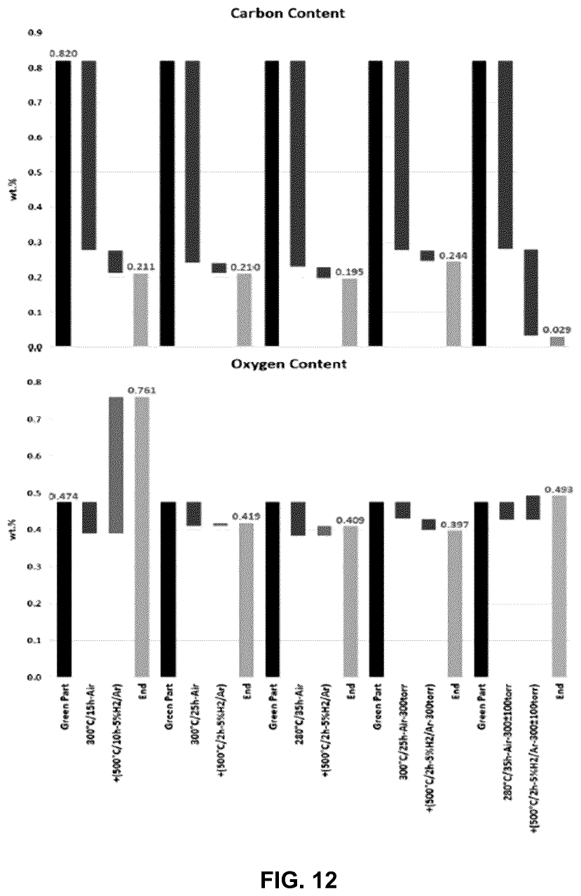

Results using partial vacuum conditions, as shown in FIG. 12, demonstrated enhanced carbon removal and moderate control of oxygen uptake. However, to achieve more precise control over oxidation and ensure uniform carbon removal across the entire part, the method of fluctuating partial vacuum pressure was implemented. This method involved alternating between higher and lower vacuum pressures, allowing air to penetrate deeper into the part while simultaneously reducing the risk of excessive oxidation. The fluctuation in vacuum pressure facilitated a more consistent and even distribution of air throughout the material, leading to uniform carbon removal and minimized oxidation. This approach proved to be the most effective, achieving the desired balance of maximizing carbon removal while minimizing oxidation, thereby maintaining the integrity and quality of the NiTi alloy. The results underscore the importance of tailoring de-binding conditions through precise control of atmosphere, temperature, and pressure to produce high-quality components suitable for critical applications. Further tailoring of this method may involve fine-tuning the parameters to halt the de-binding process precisely when optimal carbon removal is achieved, ensuring consistent and reliable results.

Tailoring De-Binding Parameters: Simplifying the Process with Air and Vacuum Fluctuation

Based on insights gained from the experiments which explored the influence of partial vacuum and hydrogen atmospheres, the focus shifted towards tailoring the de-binding parameters to streamline the process. The initial experiments indicated that certain steps, such as prolonged soaking times and the use of hydrogen, had minimal impact on the final impurity content and could be excluded to simplify the procedure.

To refine the de-binding process, the approach centered on maintaining the concept of vacuum pressure fluctuation but exclusively using air. This method aimed to maximize carbon removal and control oxidation by optimizing the time and temperature settings, without relying on hydrogen. By eliminating less impactful steps, the process became more straightforward and efficient.

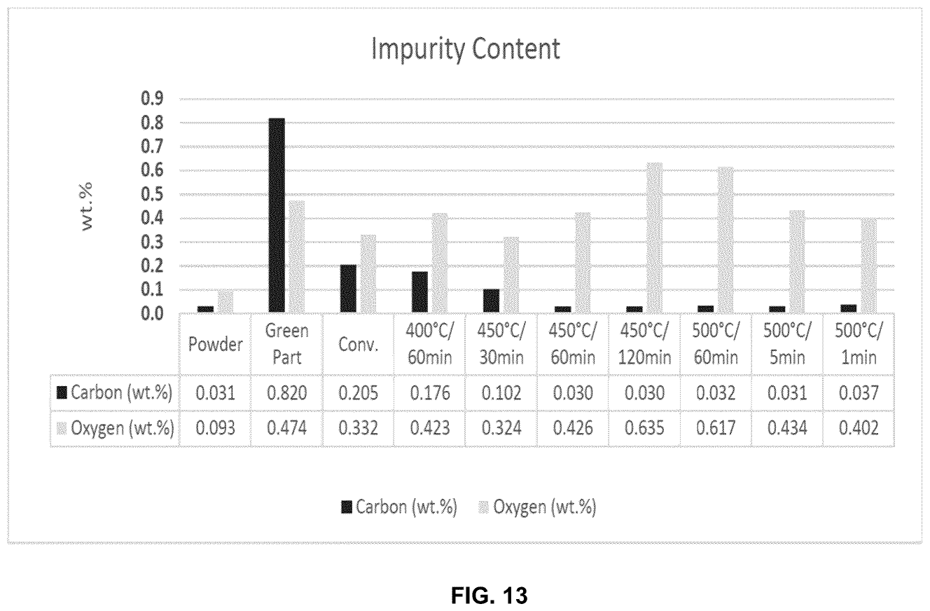

The results, shown in FIG. 13, highlight the effectiveness of this approach. Carbon content decreased significantly, from 0.820 wt. % in the green part to as low as 0.030 wt. % when de-binded at 450° C. for 60 minutes. Even at higher temperatures of 500° C., carbon content remained low, demonstrating the robustness of the air and vacuum fluctuation method. Oxygen content showed variability, with the highest levels observed at longer soak times (0.635 wt. % at 450° C. for 120 minutes), indicating that shorter processing times are preferable to limit oxidation.

This approach demonstrates that maintaining the air atmosphere with controlled vacuum pressure fluctuations is highly effective for carbon removal while minimizing oxidation. By fine-tuning the temperature and time parameters, a balance can be achieved that simplifies the de-binding process and enhances the quality of the final NiTi components.

### Furnace Parameters

The kinetics of the reaction between carbon and oxygen (in air), in addition to temperature, can depend on the amount of oxygen available or its opportunity to contact carbon. In this context, the size of the furnace and oxygen flow are important factors in the de-binding process. In the examples using air, the time and temperature were adjusted using a 50 mm OD tube furnace with an air flow of 100 ml/min at ambient pressure. The flow rate could fluctuate, as could the vacuum pressure.

### NiTiHf

The same vacuum pressure fluctuation de-binding method was conducted with NiTiHf15. The ideal parameters for the de-binding were found to be either (1) a temperature of 350° C., a time of 60 minutes, and a vacuum pressure ranging from 150 torr to 450 torr, or (2) a temperature of 400° C., a time of 1 minute, and a vacuum pressure ranging from 150 torr to 450 torr. However, other parameters may be similarly advantageous depending on factors such as the binder used and the geometry of the part.

### Conclusion

These examples demonstrate a de-binding method for NiTi parts in binder jetting additive manufacturing, focused on reducing carbon content while effectively controlling oxidation. By tailoring the use of air with fluctuating vacuum pressure, significant improvements in carbon removal were achieved, reducing carbon content to as low as 0.030 wt. % without leading to excessive oxygen uptake. The method's alternating vacuum pressures allowed for deeper air penetration and more uniform distribution, resulting in consistent carbon removal and minimized oxidation across the entire part.

Importantly, this approach also demonstrated its capability to handle parts with greater thicknesses, overcoming a common limitation in conventional de-binding methods. Additionally, the use of air with vacuum fluctuation avoids the issues associated with hydrogen, such as segregation of the main alloying elements, making it suitable for materials where hydrogen could negatively affect the material composition and properties. This method not only simplifies the de-binding process but also eliminates the need for hydrogen, enhancing the quality and reliability of NiTi components, particularly for high-performance applications like medical devices.

These findings provide a pathway for broader applications in additive manufacturing, including the use in other binder-based processes such as metal injection molding. The approach may ensure consistent and reliable results for a wide range of materials and manufacturing scenarios.

### Example 2

### Introduction

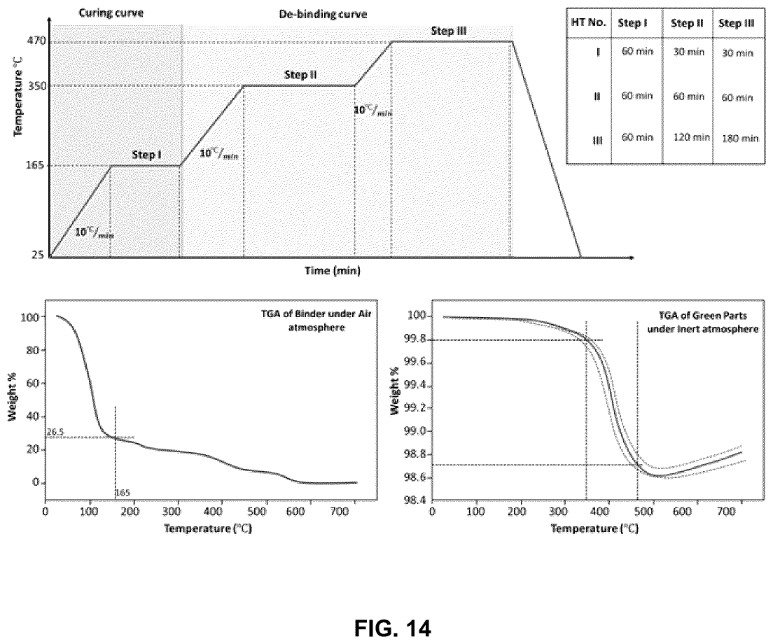

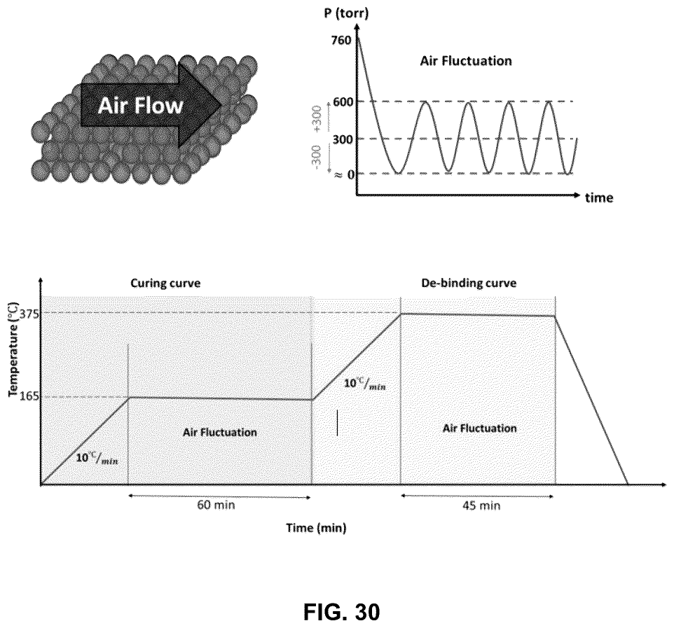

The following examples are provided with the purpose to validate technical feasibility, refine process parameters, and generate supporting data for the technological advancement of the herein-described methods. NiTi—Cu alloys were developed through a binder jet additive manufacturing method and then de-binded through the processes described herein. In the following examples, the de-binding process of NiTiCu green parts (fabricated via binder jet additive manufacturing) was investigated using two distinct methods including conventional de-binding techniques and the de-binding methods described herein. FIG. 14 illustrates six different conventional de-binding routes performed under static atmospheres, while FIG. 30 illustrates the approach of the present disclosure.

### Oxygen Pick Up

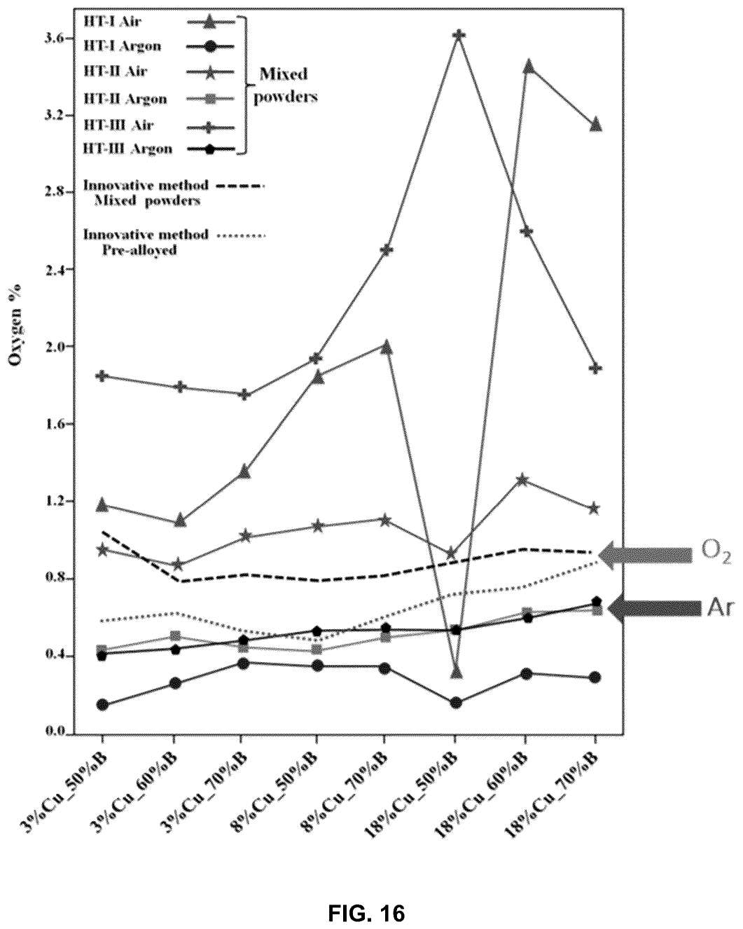

Approximately 80 tests were conducted, in which the oxygen uptake and residual carbon content of each sample were evaluated as the primary indicators for comparing the conventional and presently-described de-binding procedures. The summary of oxygen uptake, illustrated in FIG. 16, demonstrates that samples processed using the de-binding method exhibited significantly lower oxidation compared to those treated under static air atmospheres in classical approaches. Notably, the minor oxidation observed was comparable to that achieved with inert gas de-binding. Furthermore, the results confirm that the method not only reduces the total process time to less than two hours, as illustrated in FIG. 30, which is a substantially shorter time than more than three hours required by convention techniques, as illustrated in FIG. 14, but the method also yields final parts with oxidation levels markedly lower than static air processing and closely approaching those obtained under inert static conditions.

### Consistency of Composition

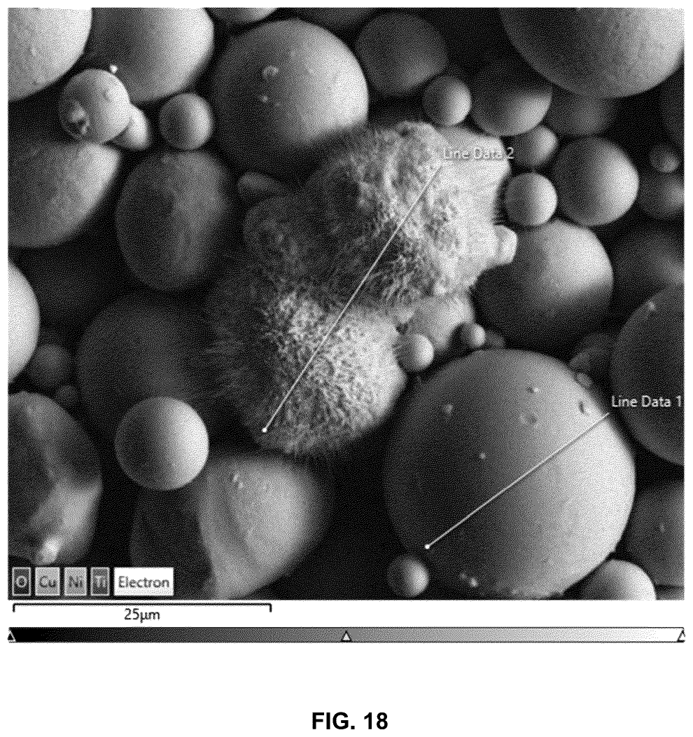

The findings regarding consistency are particularly important because they are consistent with previously mentioned results, thereby confirming the reliability and reproducibility of this process. Moreover, samples de-binded using the method described herein exhibited a uniform and monolithic composition with respect to oxidation, without any significant compositional gradients across the specimen. As illustrated in FIG. 18, samples processed under classical static atmospheres display surface color gradients indicative of oxidation, whereas those treated with the method described herein remain nearly uniform in appearance, showing no visible color variation.

### Microstructure Comparison

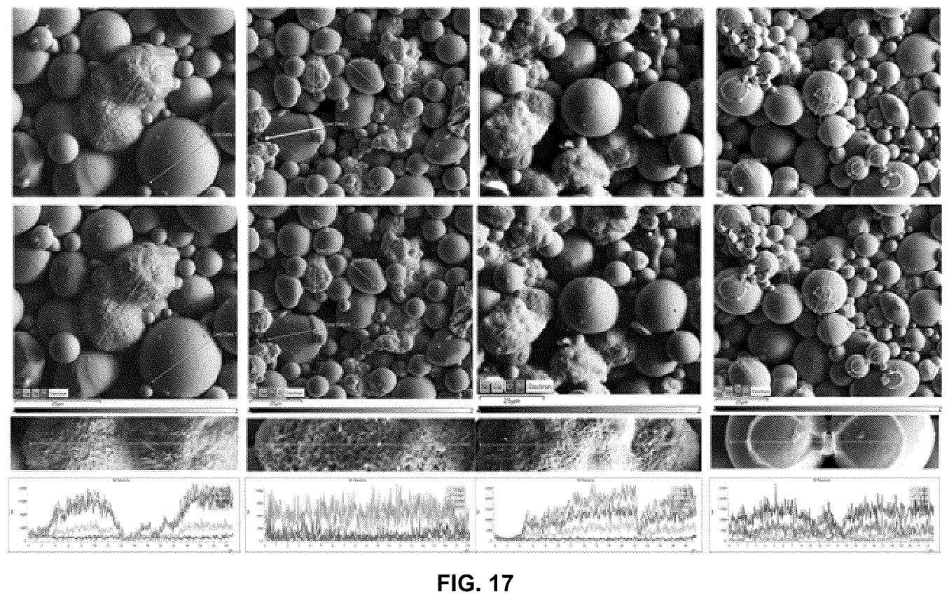

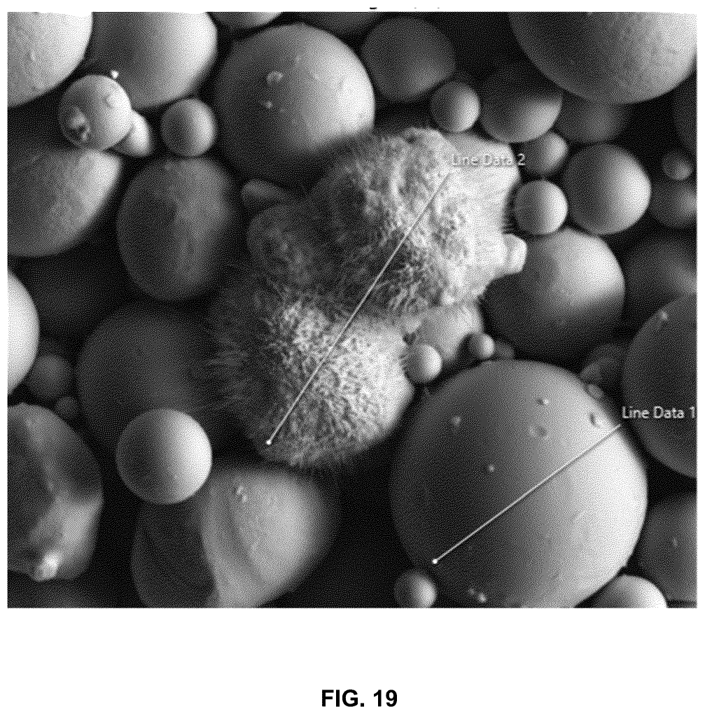

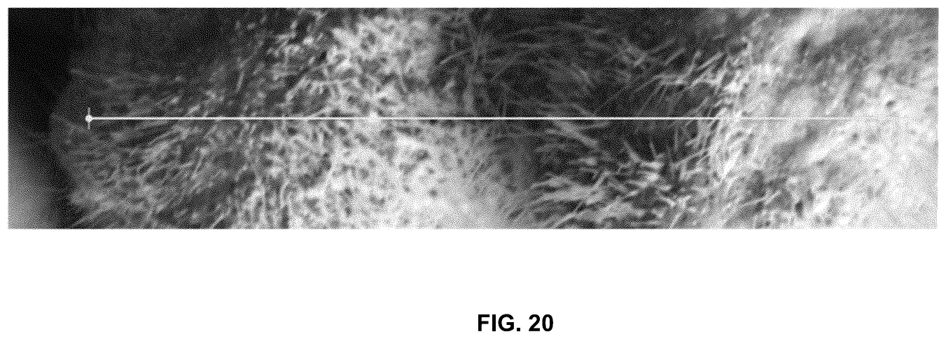

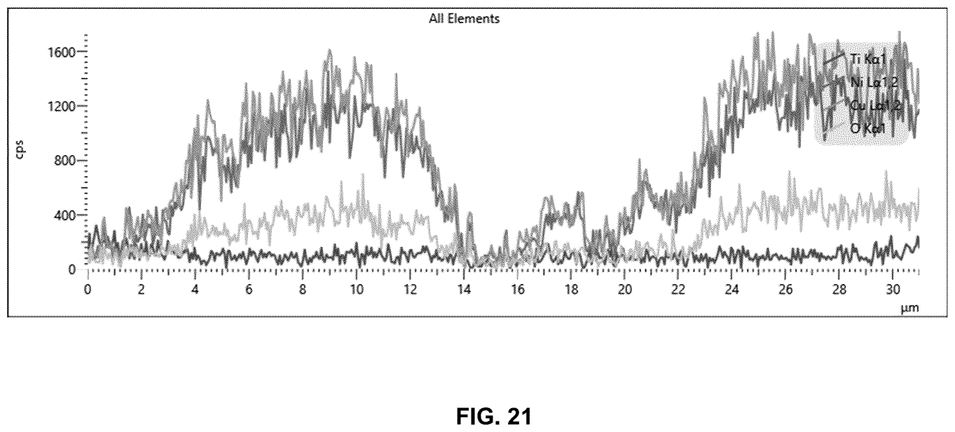

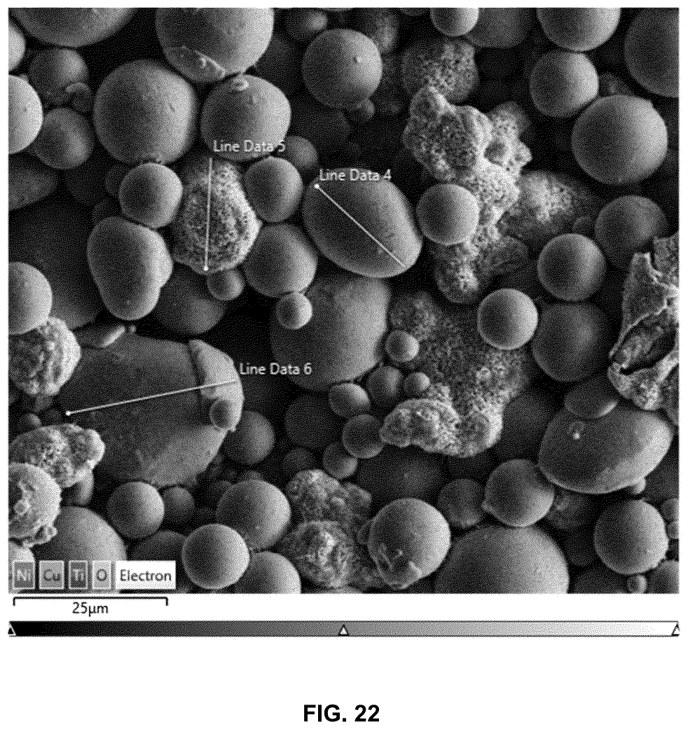

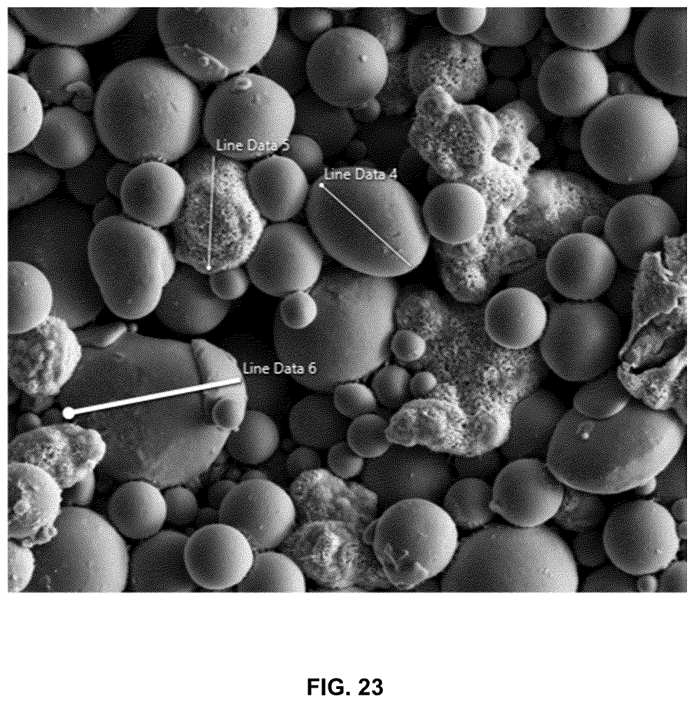

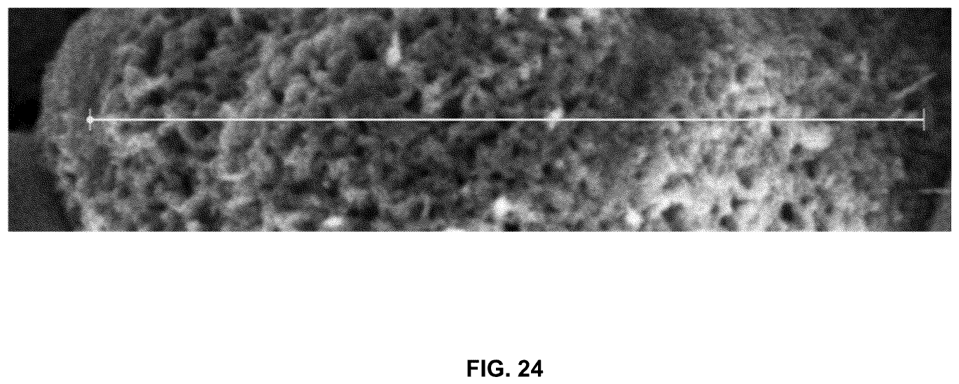

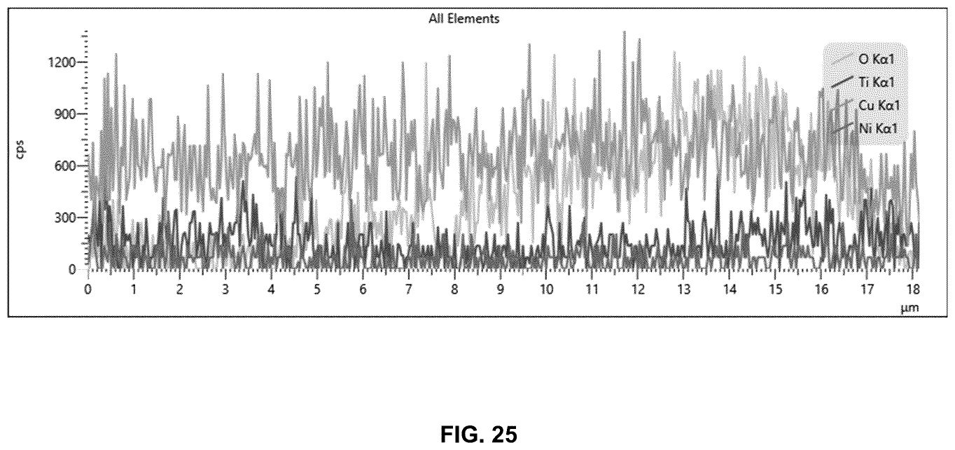

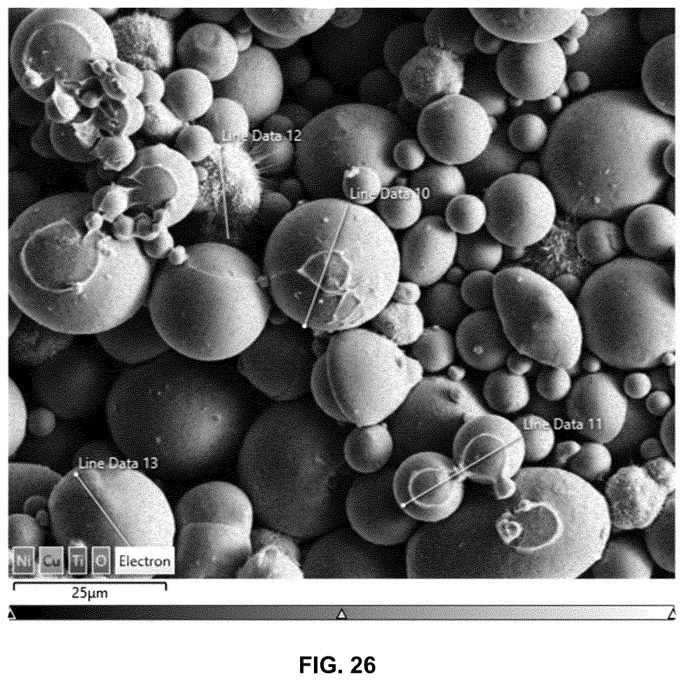

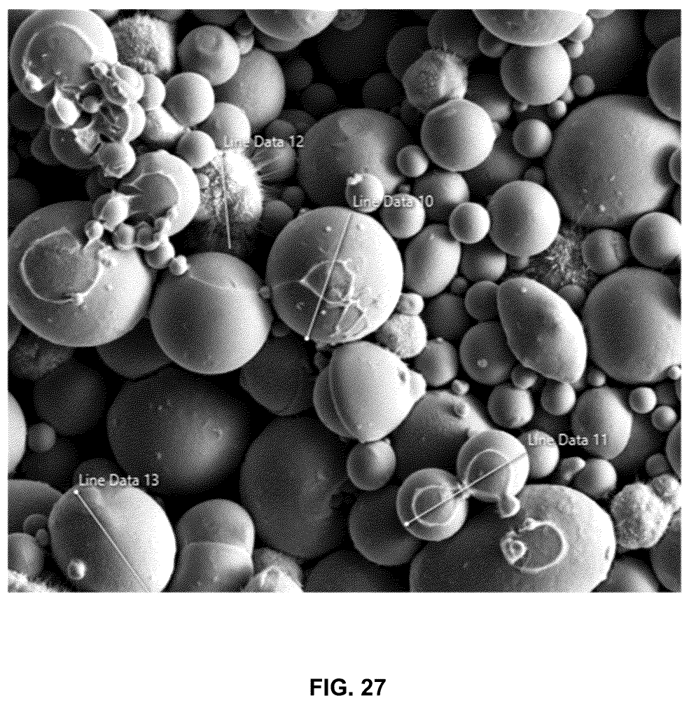

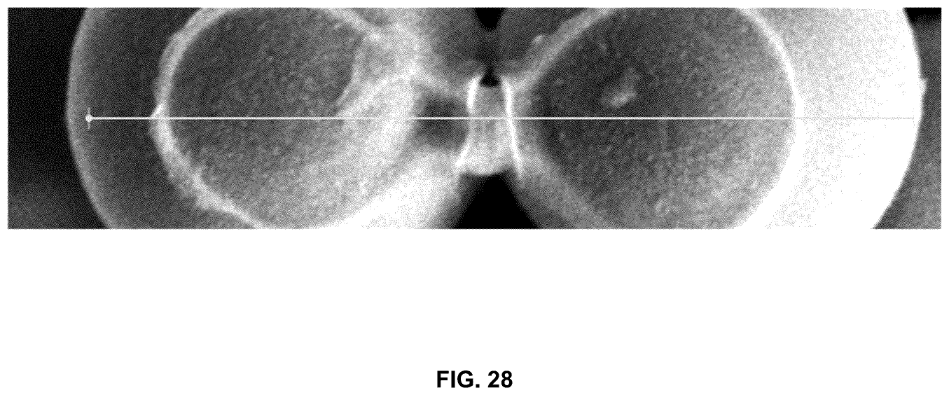

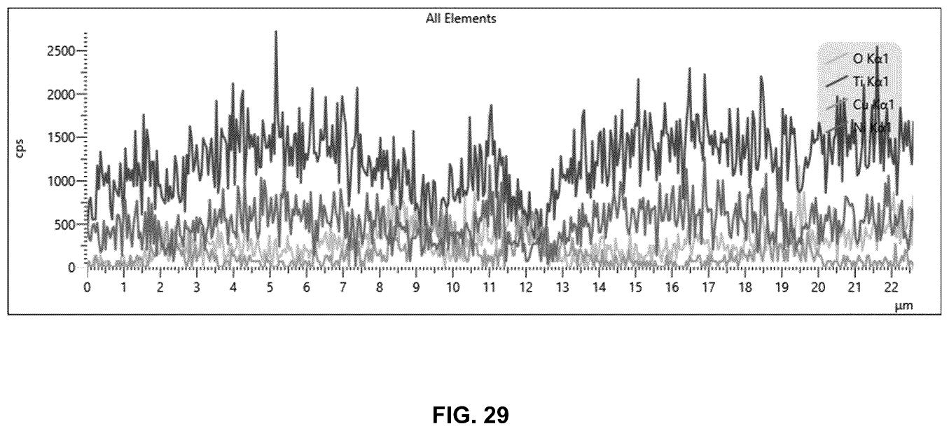

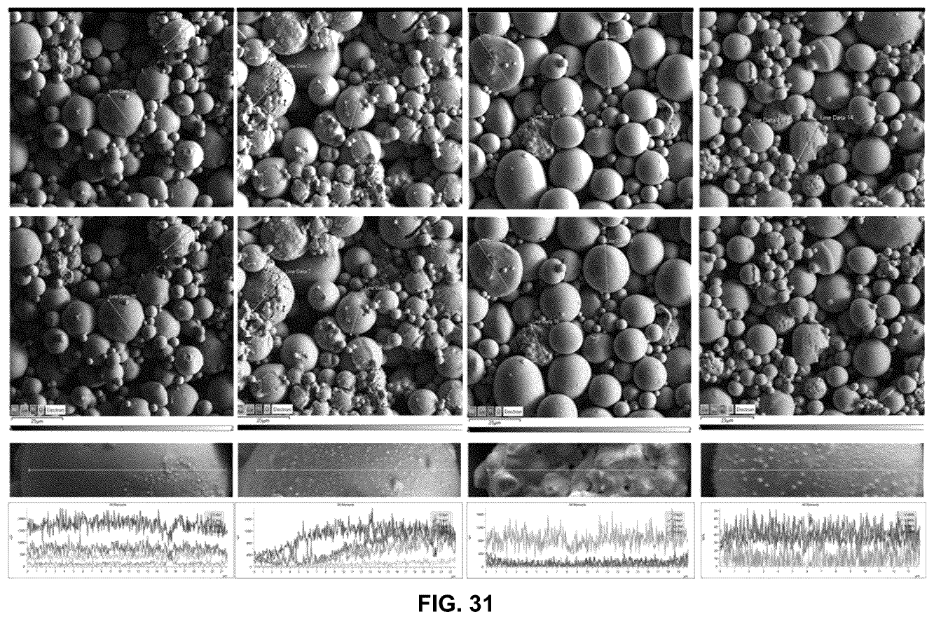

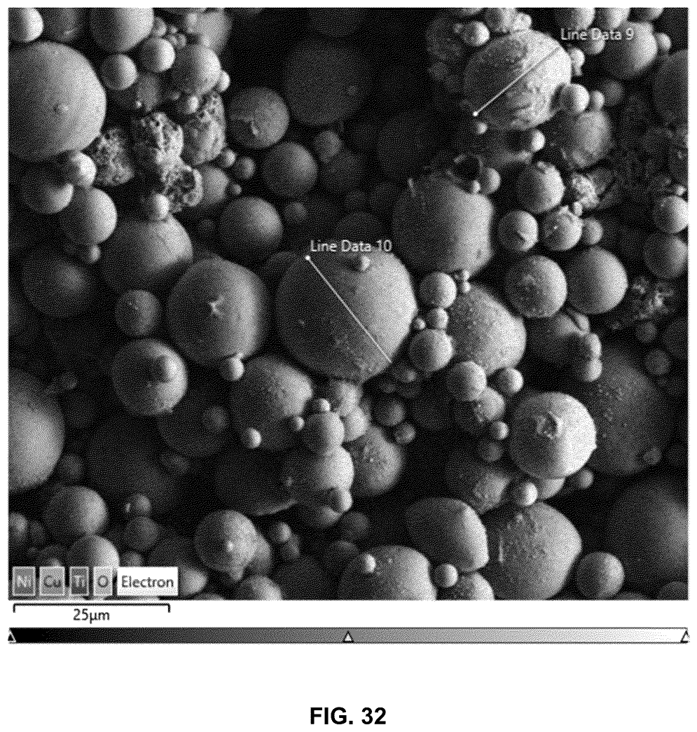

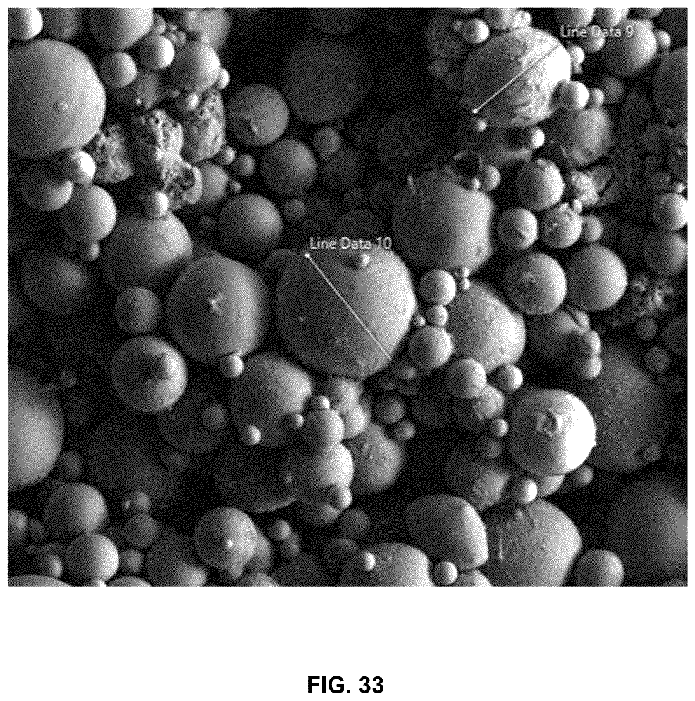

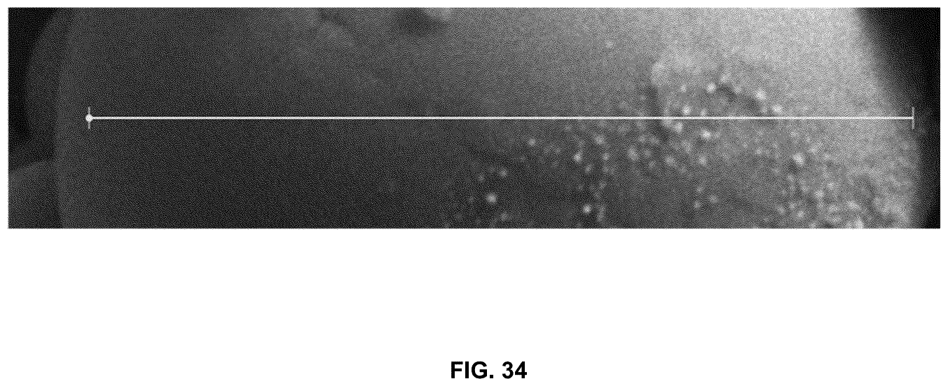

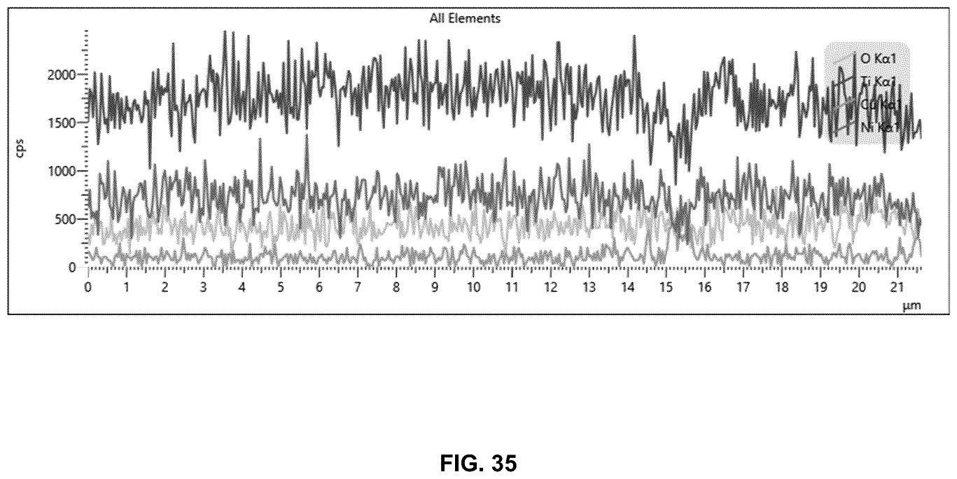

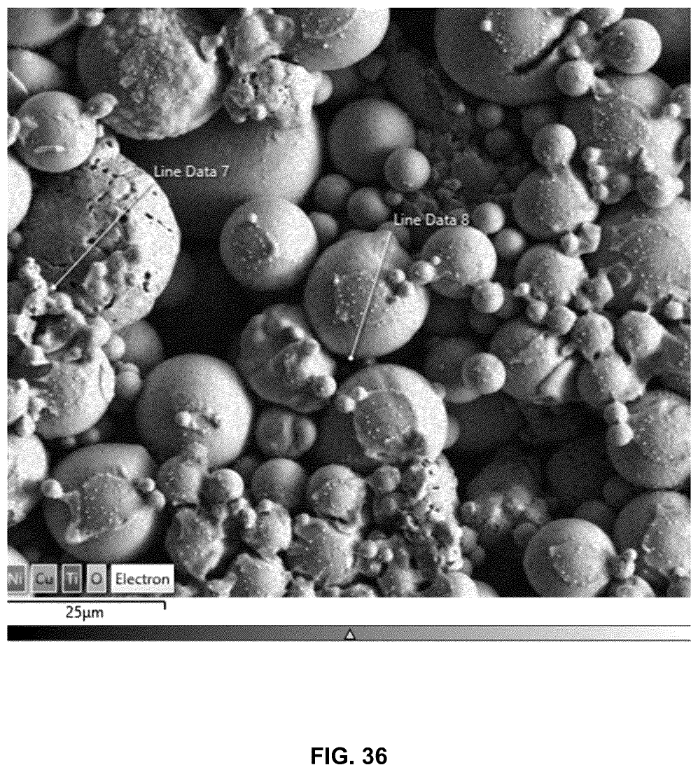

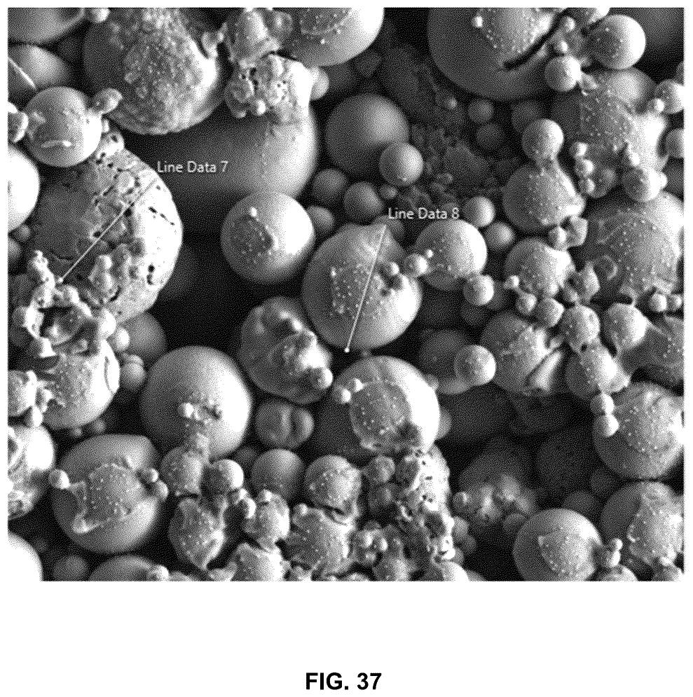

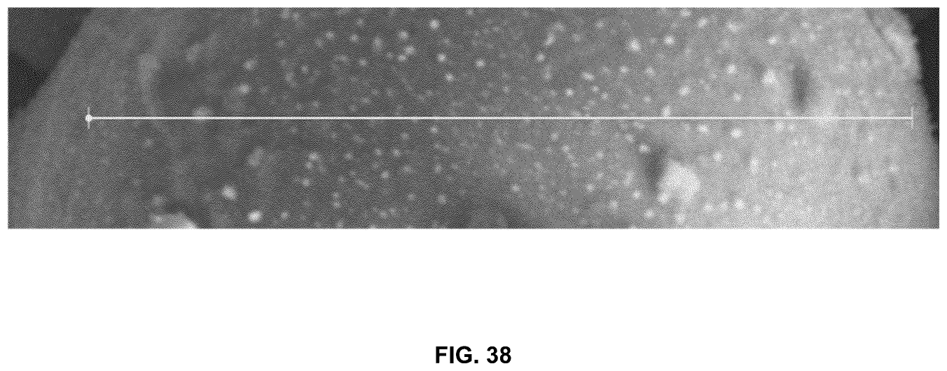

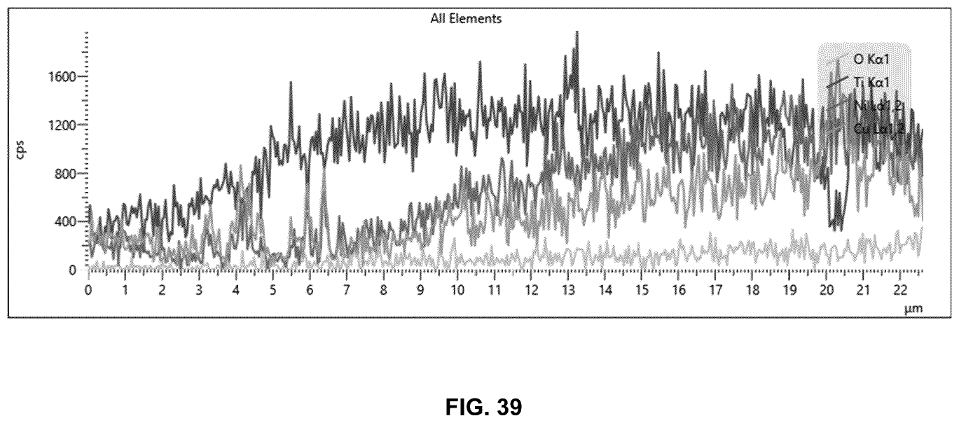

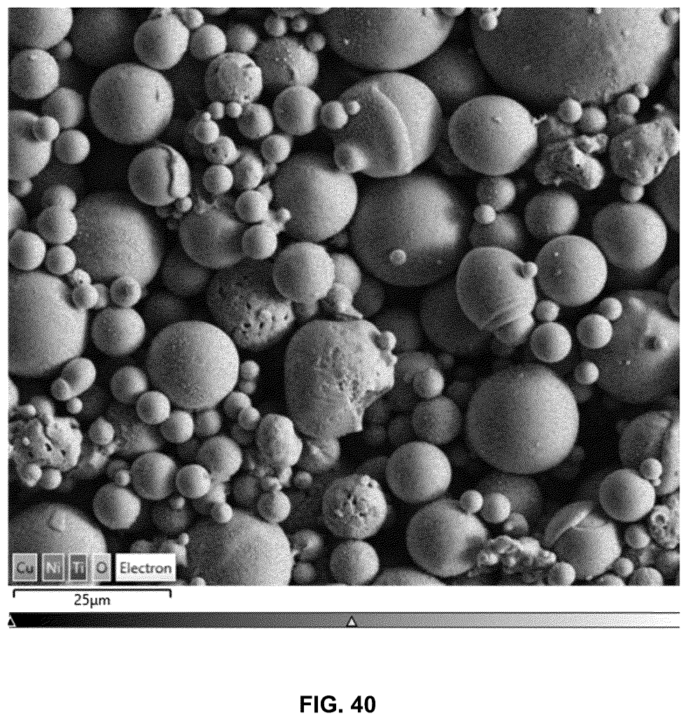

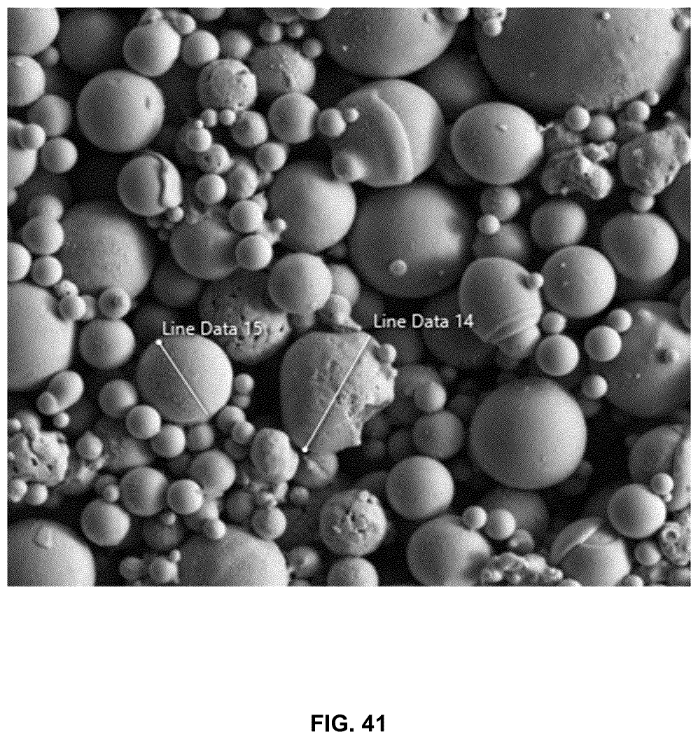

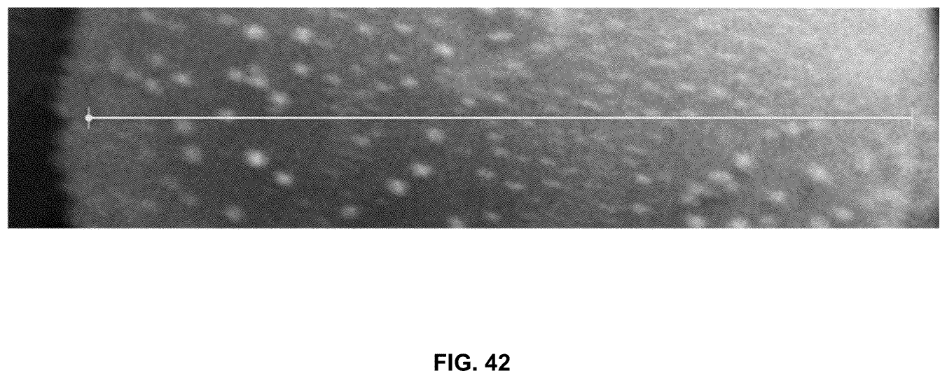

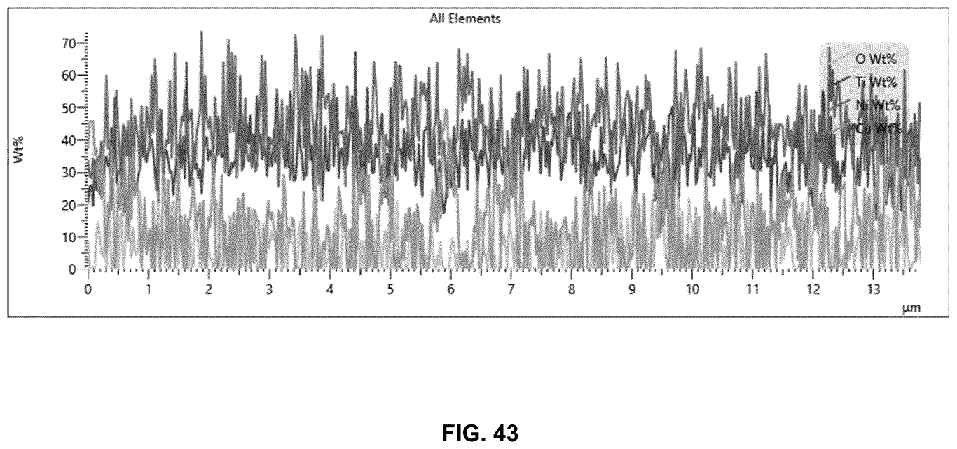

To further investigate the influence of the de-binding process on microstructural characteristics, SEM/EDS analyses were performed on samples processed under both the process and static air conditions. The results, illustrated in FIGS. 17-29 and 31-43, provide a direct comparison at the microstructural level. FIGS. 17-29 show the SEM/EDS micrographs of a de-binded sample produced by the classical method under static air atmosphere, corresponding to HT II in FIG. 17, while FIGS. 31-43, display the SEM/EDS results of samples processed using the method described herein.

As evident from FIGS. 17-29 and 31-43, oxidation within the microstructure is significantly higher in samples produced by the classical method compared to those treated with the method described herein. In these figures, the green particles correspond to Cu, while the remaining particles represent NiTi. Given its high reactivity with oxygen, Cu serves as a sensitive indicator for assessing the effect of the de-binding process on oxidation. In FIGS. 17-29, the Cu particles are almost entirely covered by fine needle-like oxide formations, and the surrounding NiTi particles also exhibit noticeable oxidation, as confirmed by EDS line analysis. By contrast, in FIGS. 31-43, oxidation is far less pronounced; the surfaces of both Cu and NiTi particles appear relatively clean and uniform, without the presence of prominent oxide needles.

### Conclusion

This example demonstrates that the method described herein has a pronounced effect on controlling oxygen uptake, resulting in final parts with smoother and more consistent surface integrity. Further, microstructural analysis confirmed that oxidation under the method, even when applied in fluctuating air conditions, was significantly lower than in static atmospheres, which aligns with the measured oxygen results illustrated in FIG. 16. Consequently, the method effectively reduces oxygen pickup, ensures a more uniform and monolithic surface quality, and shortens the overall process time, thereby lowering energy consumption compared to classical techniques.

Certain embodiments of the compositions and methods disclosed herein are defined in the above examples. It should be understood that these examples, while indicating particular embodiments of the invention, are given by way of illustration only. From the above discussion and these examples, one skilled in the art can ascertain the essential characteristics of this disclosure, and without departing from the spirit and scope thereof, can make various changes and modifications to adapt the compositions and methods described herein to various usages and conditions. Various changes may be made and equivalents may be substituted for elements thereof without departing from the essential scope of the disclosure. In addition, many modifications may be made to adapt a particular situation or material to the teachings of the disclosure without departing from the essential scope thereof.

What is claimed is:

1. A method for de-binding a green part in an additive manufacturing process, the method comprising:
providing a green part from an additive manufacturing process, the green part comprising a binder; and
heating the green part in a chamber at an elevated temperature for a period of time while fluctuating vacuum pressure of the chamber to create alternating moments of higher and lower pressure to remove the binder from the green part and produce a part ready for sintering.

2. The method of claim 1, wherein the additive manufacturing process is a binder jetting process.

3. The method of claim 1, wherein the chamber comprises air.

4. The method of claim 1, wherein the elevated temperature is greater than a temperature at which the binder decomposes.

5. The method of claim 1, wherein the elevated temperature is between about 200° C. and about 500° C.

6. The method of claim 1, further comprising sintering the part.

7. The method of claim 6, wherein the sintering is conducted in hydrogen or air.

8. The method of claim 1, wherein the part comprises stainless steel, NiTiHf, a nickel-chromium-based alloy, copper, a titanium alloy, aluminum, a tool steel, a cobalt-chrome alloy, silica sand, alumina, silicon carbide, zirconia, hydroxyapatite, polymethyl methacrylate (PMMA), nylon, polypropylene, polycarbonate, a gypsum-based material, a sand-ceramic blend, a metal-ceramic blend, glass, a plaster-based material, quartz sand, chromite sand, olivine sand, graphite, a carbon fiber-reinforced material, a ferrous alloy, a non-ferrous alloy, a superalloy, a shape memory alloy, an amorphous alloy, a high entropy alloy, an intermetallic alloy, a refractory metal alloy, a solder alloy, a bearing alloy, a dental alloy, a polymer blend or alloy, a composite material, a ceramic alloy, an elastomer blend, a bio-composite, a hybrid composite, a nonmetallic conductive alloy, a high-performance nonmetallic alloy, a liquid crystal polymer, or a combination thereof.

9. The method of claim 1, wherein the additive manufacturing process is selected from the group consisting of fused deposition modeling (FDM), stereolithography (SLA), digital light processing (DLP), selective layer sintering (SLS), electron beam melting (EBM), direct metal layer sintering (DMLS), directed energy deposition (DED), ultrasonic additive manufacturing (UAM), laminated object manufacturing (LOM), material jetting, a hybrid additive manufacturing process, and a ceramic additive manufacturing process.

10. The method of claim 1, wherein the binder comprises polyvinyl alcohol, a furan resin, a phenolic resin, polyurethane, sodium silicate, a gypsum-based binder, colloidal silica, an aqueous polymer solution, water with dispersants or surfactants, an epoxy-based binder, an acrylate resin, a methacrylate-based resin, a polymer-latex binder, or a combination thereof.

11. The method of claim 1, wherein the fluctuating promotes uniform oxidation and carbon removal throughout the green part.

12. The method of claim 1, wherein the fluctuating vacuum pressure comprises lowering a pressure of the chamber to a first vacuum pressure for a first period of time, then increasing the pressure of the chamber to a second vacuum pressure for a second period of time, wherein each of the first vacuum pressure and the second vacuum pressure is below 760 torr.

13. The method of claim 12, further comprising lowering the pressure of the chamber back to the first vacuum pressure for a third period of time, or lowering the pressure of the chamber to a third vacuum pressure for a third period of time, wherein the first vacuum pressure and the third vacuum pressure are different.

14. A method for de-binding and sintering of a printed part from a binder jetting process, the method comprising:
providing a printed part from an additive manufacturing process, the printed part comprising a binder;
heating the printed part to a first elevated temperature for a first period of time in air to remove some of the binder;
sintering the printed part at a first pressure and a second elevated temperature, or an increasing elevated temperature, in hydrogen for a second period of time;
heating the printed part at a third elevated temperature in hydrogen for a third period of time; and
treating the printed part at a second pressure in hydrogen for a fourth period of time to complete the binder removal and sintering of the printed part;
wherein the second elevated temperature is greater than the first elevated temperature, the third elevated temperature is greater than the second elevated temperature, and the second pressure is greater than the first pressure.

15. The method of claim 14 wherein the first elevated temperature is in a range of from about 275° C. to about 325° C.

16. The method of claim 14, wherein the first period of time is about 2 hours.

17. The method of claim 14, further comprising transferring the printed part to a separate furnace after the heating in air.

18. The method of claim 14, wherein the additive manufacturing process is selected from the group consisting of fused deposition modeling (FDM), stereolithography (SLA), digital light processing (DLP), selective layer sintering (SLS), electron beam melting (EBM), direct metal layer sintering (DMLS), directed energy deposition (DED), ultrasonic additive manufacturing (UAM), laminated object manufacturing (LOM), material jetting, a hybrid additive manufacturing process, and a ceramic additive manufacturing process.

19. The method of claim 14, wherein the first pressure is about 300 torr and the second pressure is about 600 torr.

20. A method for producing a three-dimensional object, the method comprising:
depositing a layer of a powdered material onto a build platform;
selectively dispensing a liquid binder onto specific regions of the layer of powdered material, based on a digital model of an object to be printed, thereby causing the powdered material in the specific regions to bind together;
repeating the depositing and the selectively dispensing for multiple layers, wherein each subsequent layer is deposited onto previously bound regions of the powdered material, to form a printed structure through layer-by-layer accumulation;
curing the printed structure;
removing unbound powdered material from the printed structure;
de-binding the printed structure to remove excess binder, wherein the de-binding comprises fluctuating vacuum pressure of a chamber housing the printed structure; and
sintering the printed structure to produce a three-dimensional object.
